(19) United States
(12) Patent Application Publication
(10) Pub. No.: US 2014/0149872 A1
(43) Pub. Date: May 29, 2014

(54) COMMUNICATION CONNECTION METHOD, COMMUNICATION CONNECTION APPARATUS, AND COMMUNICATION CONNECTION PROGRAM

(71) Applicant: SONY CORPORATION, Tokyo (JP)

(72) Inventor: Akihiro Komori, Tokyo (JP)

(73) Assignee: SONY CORPORATION, Tokyo (JP)

(21) Appl. No.: 14/119,291

(22) PCT Filed: May 9, 2012
(86) PCT No.: PCT/JP2012/062439

§ 371 Date: Nov. 21, 2013

(30) Foreign Application Priority Data
Jun. 1, 2011 (JP) 2011-123550

(51) Int. Cl. H04L 29/08

(52) U.S. Cl. CPC H04L 67/141
USPC 715/736

(57) ABSTRACT

A communication connection apparatus may include a display unit to display an image of a device selected as a communication target with which to establish a communication connection. The apparatus may further include a processing unit to update a progress informing image for informing progress of a communication connection synthesized with the selected device image.

### TECHNICAL FIELD

The present invention relates to a communication connection method, a communication connection apparatus, and a communication connection program, which are suitably applied, for example, to a device having a communication function based on a near-field wireless communication standard and a mobile terminal capable of establishing a communication connection based on the near-field wireless communication standard.

### BACKGROUND ART

A conventional mobile type information processing terminal has an imaging function with the use of a built-in or externally attached camera as well as a communication function based on the near-field wireless communication standard.

In so doing, the mobile type information processing terminal can, with the use of a camera, image a target such as an information device or a home information appliance having the same communication function based on the near-field wireless communication standard as that in the mobile type information processing terminal.

However, for the target, a CyberCode which expresses an ID code of the target is provided in a visually identifiable state on the surface thereof.

Therefore, the mobile type information processing terminal obtains, with the use of the camera, a network address of the target based on the CyberCode photographed in a captured image when the mobile type information processing terminal images the target along with the CyberCode on the surface thereof and obtains the captured image.

In addition, the mobile type information processing terminal establishes a communication connection with the target (namely, the target imaged at this time) with the use of the network address obtained at this time while displaying the captured image, for example, on a display.

In so doing, the conventional mobile type information processing terminal can establish a communication connection with the target only by allowing a user to image the target as a communication target (see Patent Literature 1, for example).

### CITATION LIST

### Patent Literature

PTL 1: Japanese Patent No. 4178697 (pp. 18 and 19)

### SUMMARY OF INVENTION

However, the mobile type information processing terminal executes communication connection processing in practice to automatically exchange a signal several times for communication connection with the target and finally establishes communication connection when the mobile type information processing terminal makes communication connection with the target (that is, into a state in which it is possible to transmit and receive data).

However, the mobile type information processing terminal takes a relatively long processing time such as several tens of seconds, for example, from start of the communication connection processing and establishment of the communication connection with the target until completion of the communication connection processing.

Therefore, the mobile type information processing terminal displays a comment, a figure, or the like which indicates that the communication connection processing is being executed on a display, for example, during the execution of the communication connection processing.

However, mobile type information processing terminal cannot allow a user to recognize to what extent the communication connection processing has progressed only by displaying a comment, a figure, or the like during the execution of the communication connection processing.

Therefore, there is a problem with the mobile type information processing terminal in that the user is made to wait for the establishment of a communication connection while the user cannot predict when the communication connection with the target will be established at all when the communication connection processing is executed, hence usability is poor.

The present invention has been made in consideration of the above points in order to propose a communication connection method, a communication connection apparatus, and a communication connection program which are capable of enhancing the usability of a communication connection apparatus.

In accordance with one embodiment, a communication connection apparatus may include a display unit to display an image of a device selected as a communication target with which to establish a communication connection. In addition, the apparatus may include a processing unit to update a progress informing image for informing progress of a communication connection synthesized with the selected device image.

In accordance with another embodiment, a method for communication connection may include displaying an image of a device selected as a communication target with which to establish a communication connection. In addition, the method may include updating, by a processor, a progress informing image for informing progress of a communication connection synthesized with the selected device image.

In accordance with another embodiment, a non-transitory recording medium may be recorded with a program executable by a computer, where the program includes displaying an image of a device selected as a communication target with which to establish a communication connection; and updating a progress informing image for informing progress of a communication connection synthesized with the selected device image.

### BRIEF DESCRIPTION OF DRAWINGS

FIG. 1 is a block diagram showing an outline of a configuration of a communication connection apparatus according to an embodiment.

FIG. 2 is a block diagram showing a configuration of a communication connection system according to an embodiment.

FIG. 3 is an outlined line drawing showing an appearance configuration of a mobile terminal as a specific example of a communication connection apparatus according to an embodiment.

FIG. 4 is a block diagram showing a circuit configuration of a mobile terminal as a specific example of a communication connection apparatus according to an embodiment.

FIG. 5 is an outlined line drawing for illustration of a device with a code sticker attached thereto.

FIG. 6 is an outlined line drawing showing a configuration of a two-dimensional code.

FIG. 7 is an outlined line drawing for illustration of a device without a code sticker attached thereto.

FIG. 8 is an outlined line perspective view showing a configuration of a three-dimensional spatial image.

FIG. 9 is an outlined line perspective view for illustration of generation of a three-dimensional spatial image in which a device icon of a selected device is arranged.

FIG. 10 is an outlined line drawing for illustration of display of a selected device image by a mobile terminal.

FIG. 11 is an outlined line drawing for illustration of display of a selected device image by a mobile terminal.

FIG. 12 is an outlined line drawing for illustration of display of a selected device image by a mobile terminal.

FIG. 13 is an outlined line drawing for illustration of selection of a communication target device on a selected device image.

FIG. 14 is an outlined line drawing for illustration of division of an inter-position line segment in accordance with the progress situation informing level of communication connection processing.

FIG. 15 is an outlined line perspective view for illustration of arrangement of a progress situation informing image in a three-dimensional spatial image.

FIG. 16 is an outlined line drawing for illustration of synthesis of a progress situation informing image with a selected device image.

FIG. 17 is an outlined line perspective view for illustration of arrangement of a progress situation informing image in a three-dimensional spatial image.

FIG. 18 is an outlined line drawing for illustration of update of a progress situation informing image in a selected device image.

FIG. 19 is an outlined line perspective view for illustration of arrangement of a progress situation informing image in a three-dimensional spatial image.

FIG. 20 is an outlined line drawing for illustration of update of a progress situation informing image in a selected device image.

FIG. 21 is an outlined line perspective view for illustration of arrangement of a progress situation informing image in a three-dimensional spatial image.

FIG. 22 is an outlined line drawing for illustration of update of a progress situation informing image in a selected device image.

FIG. 23 is an outlined line perspective view for illustration of arrangement of a progress situation informing image in a three-dimensional spatial image when communication connection is established.

FIG. 24 is an outlined line drawing for illustration of final update of a progress situation informing image in a selected device image.

FIG. 25 is an outlined line drawing showing a configuration of a selected device image when a communication target device cannot be searched for.

FIG. 26 is an outlined line drawing showing a configuration of a selected device synthesized image.

FIG. 27 is an outlined line drawing for illustration of selection of transmission target picture image data by a tapping operation with respect to a thumbnail image.

FIG. 28 is an outlined line drawing for illustration of selection of transmission target picture image data by dragging of a thumbnail image onto a progress situation informing image.

FIG. 29 is an outlined line perspective view for illustration of arrangement of a thumbnail image in a three-dimensional spatial image in accordance with the progress situation of picture image data transmission processing.

FIG. 30 is an outlined line drawing for illustration of informing of a progress situation of transmission processing by a selected device image.

FIG. 31 is an outlined line perspective view for illustration of arrangement of a thumbnail image in a three-dimensional spatial image in accordance with the progress situation of picture image data transmission processing.

FIG. 32 is an outlined line drawing for illustration of informing of a progress situation of transmission processing by a selected device image.

FIG. 33 is an outlined line drawing showing a configuration of a selected device image when transmission of picture image data has been completed.

FIG. 34 is an outlined line drawing for illustration of a disconnection instruction of communication connection on a selected device image.

FIG. 35 is an outlined line drawing showing a configuration of a selected device image when communication connection with a communication target device is disconnected.

FIG. 36 is an outlined line drawing for illustration of a reconnection instruction with a device on a selected device image.

FIG. 37 is a flowchart showing a procedure of communication connection processing.

FIG. 38 is a flowchart showing a sub-routine of progress situation informing processing.

FIG. 39 is an outlined line drawing showing a modified example of communication connection between a mobile terminal and a communication target device.

FIG. 40 is an outlined line drawing showing a modified example of a progress situation informing image.

### DESCRIPTION OF EMBODIMENTS

Hereinafter, best modes for carrying out the invention (hereinafter, this will also be referred to as an embodiment) will be described with reference to drawings. In addition, the description will be given in the following order.

1. Embodiment

2. Modified Examples

### 1. Embodiment

### 1-1. Configuration Outline of Communication Connection Apparatus According to Embodiment

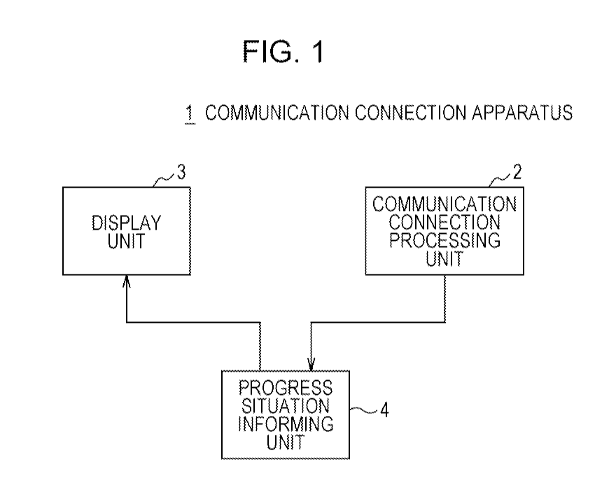

First, an outline of the embodiment will be described. Moreover, after the outline is described, description will move on to a specific example of the embodiment. In FIG. 1, 1 represents as a whole a communication connection apparatus according to the embodiment.

In such a communication connection apparatus 1, a communication connection processing unit 2 establishes a communication connection processing for establishing a communication connection with a device selected as a communication target.

In addition, in the communication connection apparatus 1, a display unit 3 displays a selected device image showing a communication target device when the communication connection processing is started by the communication connection processing unit 2.

Furthermore, in the communication connection apparatus 1, a progress situation informing unit 4 updates a progress situation informing image to be synthesized with the selected device image in accordance with the progress situation of the communication connection processing so as to synthesize the progress situation informing image for informing of the progress situation of the communication connection processing with the selected device image.

With such a configuration, the communication connection apparatus 1 can allow a user to recognize the progress situation of the communication connection processing with the progress situation informing image in the selected device image while executing the communication connection processing.

As a result, the communication connection apparatus can allow the user to wait for establishment of the communication connection in a state in which the user can predict about when the communication connection with the device will be established, while executing the communication connection processing. In so doing, the communication connection apparatus 1 can significantly enhance usability.

### 1-2. Configuration of Communication Connection System According to Embodiment

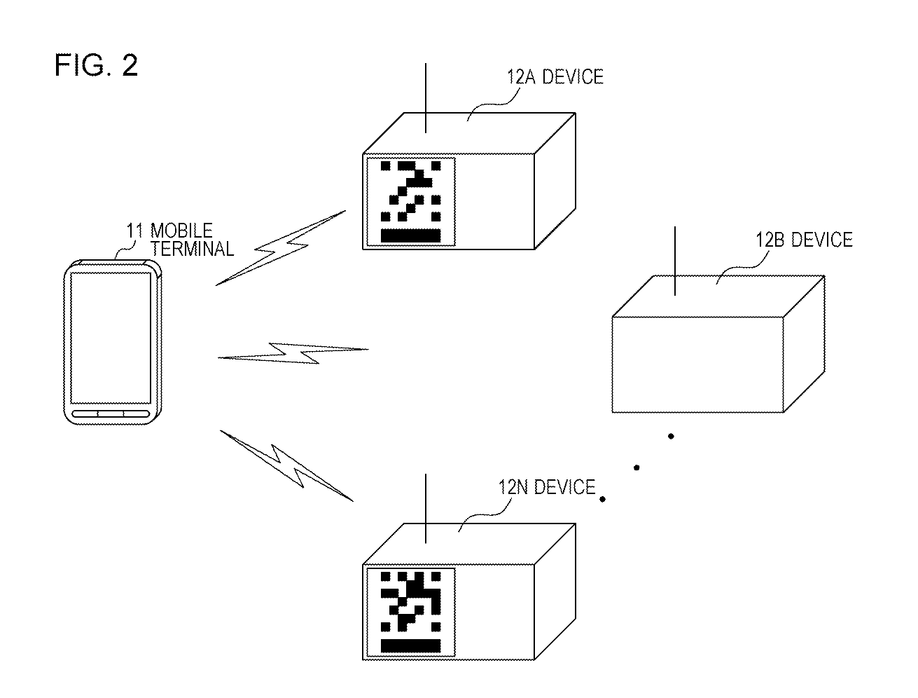

In FIG. 2, 10 represents as a whole a communication connection system according to the embodiment. Such a communication connection system 10 has a mobile terminal 11, which is called a smartphone, as a specific example of the communication connection apparatus 1 shown in the above outline.

The mobile terminal 11 has a communication function based on a near-field wireless communication standard such as the IEEE (Institute of Electrical and Electronics Engineers) 802 standard.

In addition, the communication connection system 10 also has various devices 12A to 12N such as a personal computer, a television image receiver, a wireless router, and the like with communication functions based on the same near-field wireless communication standard as that for the mobile terminal 11.

In so doing, in the communication connection system 10, the mobile terminal 11 is configured to make communication connection in a wireless manner with the various devices 12A to 12N based on the near-field wireless communication standard and can send and receive various types of data to and from the devices 12A to 12N.

### 1-3. Appearance Configuration of Mobile Terminal

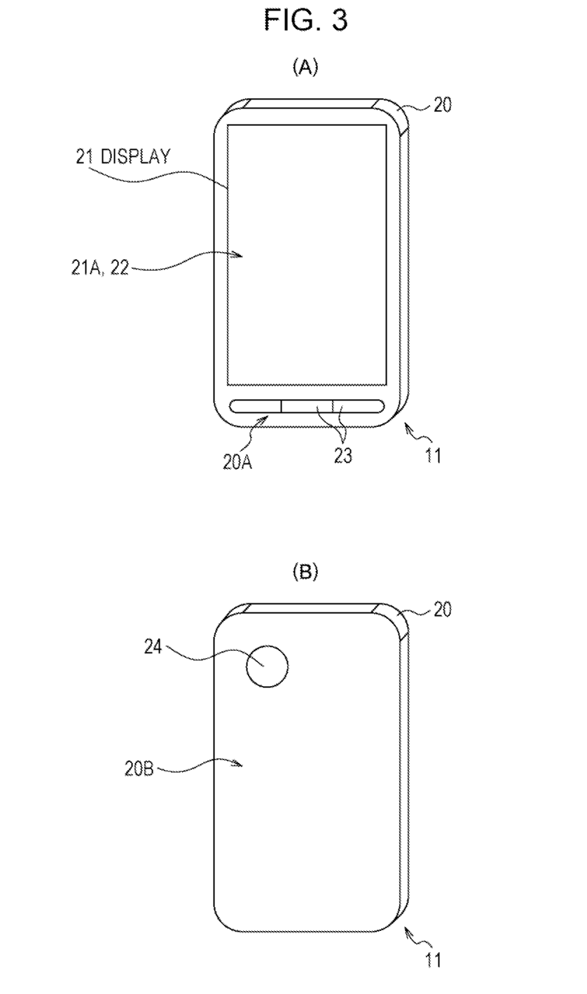

Next, an appearance configuration of the mobile terminal 11 will be described with the use of FIGS. 3(A) and (B). Such a mobile terminal 11 has a terminal case body 20 with a substantially flat rectangular shape.

In addition, in the following description, a longitudinal direction of the terminal case body 20 will also be referred to as a case body longitudinal direction, and a lateral direction of the terminal case body 20 will also be referred to as a case body lateral direction.

Moreover, in the following description, one end of the terminal case body 20 in the case body longitudinal direction will also be referred to as a case body upper end, and the other end in the case body longitudinal direction will also be referred to as a case body lower end.

Furthermore, in the following description, one end of the terminal case body 20 in the case body lateral direction will also be referred to as a case body left end, and the other end in the case body lateral direction will also be referred to as a case body right end.

Near the case body upper end in a front surface 20A of the terminal case body 20, a display surface 21A of a display 21 such as a liquid crystal display or an organic EL (Electro Luminescence) display is arranged such that the entirety of the display surface 21A is externally exposed.

In addition, on the display surface 21A of the display 21, a transparent touch panel 22 is adhered so as to cover the entire of the display surface 21A.

Moreover, in the front surface 20A of the terminal case body 20, a plurality of operation buttons 23 is disposed so as to be arranged, for example, in a line along the case body lateral direction near the lower end of the case body.

In so doing, the mobile terminal 11 can allow inputs of various instructions and orders via the touch panel 22 and the plurality of operation buttons 23.

On the other hand, in the rear surface 20B of the terminal case body 20, an imaging lens 24 of a camera unit is disposed at the right upper end of the case body such that an incidence plane thereof is externally exposed.

In so doing, the mobile terminal 11 takes imaging light which has been reached from an imaging range including an object from the imaging lens when the incidence plane of the imaging lens 24 is made to face the object along with the rear surface 20B of the terminal case body 20 and the touch panel 22 or the operation button 23 is operated to input an imaging order. In so doing, the mobile terminal 11 can take a picture of the object with the use of the camera unit.

### 1-4. Circuit Configuration of Mobile Terminal

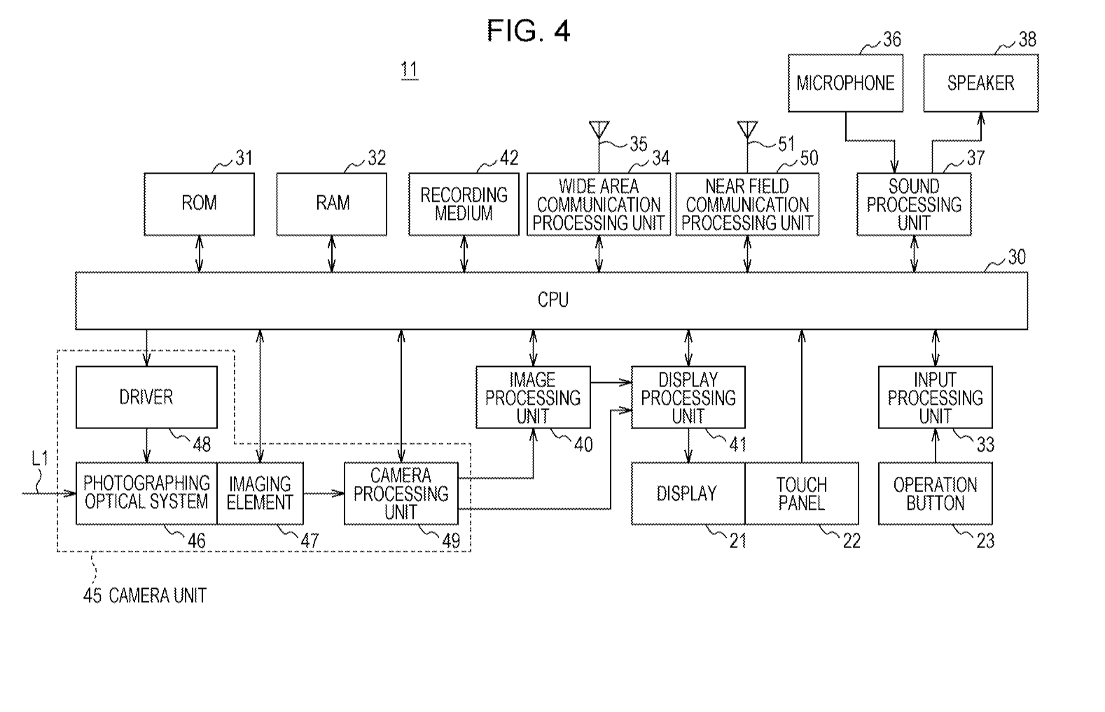

Next, with the use of FIG. 4, a circuit configuration of the mobile terminal 11 will be described. The mobile terminal 11 has a central processing unit (CPU: Central Processing Unit) 30.

The central processing unit 30 reads a basic program stored in advance in a ROM (Read Only Memory) 31 and various programs including application programs such as a communication connection program and a communication processing program into a RAM (Random Access Memory) 32.

Then, the central processing unit 30 performs overall control based on various programs developed on the RAM 32 and executes predetermined computation processing and various kinds of processing in response to user operations.

Here, when the aforementioned various operation buttons 23 are pressed and operated by the user in the mobile terminal 11, the operation buttons 23 send operation input signals in accordance with the pressing operations to an input processing unit 33.

The input processing unit 33 converts the operation input signals into operation commands by subjecting the operation input signals supplied from the operation buttons 23 to predetermined processing and sends the operation commands to the central processing unit 30.

Accordingly, when the operation buttons 23 are pressed and operated as user's operations, the central processing unit 30 executes various kinds of processing in accordance with the operation commands given from the input processing unit 33 in accordance with the pressing operations.

Incidentally, the aforementioned touch panel 22 in the mobile terminal 11 is for allowing a finger, a stylus pen, or the like to touch a surface of the touch panel 22 as if the touch panel 22 allowed the finger, the stylus pen, or the like to touch the display surface 21A of the display 21 and allowing inputs of various instructions and orders.

As operations for inputting various orders and instructions by touching the surface of the touch panel 22, there is an example in which a tip end of one finger, a tip end of one stylus pen, or the like is made to touch substantially one point on the surface of the touch panel 22 and immediately separate therefrom.

In addition, as such operations, there is also an example in which a tip end of one finger, a tip end of one stylus pen, or the like is maintained to be in touch with the surface of the touch panel 22 and made to move so as to depict a desired line drawing such as a straight line, a circle, or the like (that is, a tip end of a finger or the like is made to slide on the surface).

In addition, in the following description, the operation in which a tip end of one finger, a tip end of one stylus pen, or the like is made to touch substantially one point on the surface of the touch panel 22 and immediately separated therefrom will also be referred to as a tapping operation.

The tapping operation is an operation performed to instruct an instruction item of an icon, a button, or the like in an image on the image displayed on the display 21, for example.

In addition, in the following description, the operation in which a tip end of one finger, a tip end of one stylus pen, or the like is maintained to be in touch with the surface of the touch panel 22 and made to move so as to depict a desired line drawing will also be referred to as a sliding operation.

The sliding operation is an operation performed to drag (namely, move) a movable item such as an icon or the like in an image to a desired position on the image displayed on the display 21, for example.

In addition, the sliding operation is an operation executed in order to input an order in accordance with a position of the sliding operation on the image displayed on the display 21, a shape of a line drawing depicted by the sliding operation, or the like, for example.

In addition, in the following description, the tapping operation and the sliding operation, which are performed by allowing a tip end of a finger or the like to touch the surface of the touch panel 22, will also collectively be referred to as a touch operation when there is no particular need for discrimination.

When a touch operation is performed on the surface, the touch panel 22 detects a touch position as a coordinate of a pixel position of a display surface 21A of the display 21 every predetermined very short period such as several [μsec], for example, from the start to the end of the touch operation.

In addition, the touch panel 22 sends touch position information indicating the detected touch position to the central processing unit 30 every time the touch position is detected.

When the touch position information is given from the touch panel 22, the central processing unit 30 detects, for example, a period during which the touch position information is given as a period from the start to the end of the touch operation, during which the touch operation is performed (hereinafter, this will also be referred to as a touch operation period).

Moreover, the central processing unit 30 detects, for example, a displacement amount of the touch position indicated by the touch position information for the period, during which the touch position information is given, as a touch position displacement amount indicating to what extent the touch position has been displaced from the start to the end of the touch operation.

Then, the central processing unit 30 determines a kind of the touch operation (that is, which one of the tapping operation and the sliding operation) based on the touch operation period and the touch position displacement amount.

Accordingly, when a touch operation is performed on the surface of the touch panel 22 as a user's operation, the central processing unit 30 executes various processing in accordance with the kinds and the position of the touch operation performed on the surface of the touch panel 22.

In so doing, the central processing unit 30 can realize various functions such as a telephone call function, an obtaining function and a reproduction function of sound data such as music or the like, an object imaging function, a reproduction function of picture images obtained by the imaging, and the like based on various programs developed on the RAM 32.

In practice, the mobile terminal 11 is provided with a communication processing unit 34 and an antenna 35 used for communicating with base station of a wide area telephone line network managed and operated by telephone companies.

Such a communication processing unit 34 performs predetermined transmission processing on data for transmission and also performs predetermined receiving processing on data received by the antenna 35 based on a wireless communication standard applied to the base station of the wide area telephone line network.

In addition, the antenna 35 transmits data, which has been subjected to the transmission processing by the communication processing unit 34, to the base station and receives data transmitted from the base station.

Moreover, in the following description, the communication processing unit 34 used for communicating with the base station of the wide area telephone line network will also be referred to as a wide area communication processing unit 34, and the antenna 35 used for communicating with the base station of the wide area telephone line network will also be referred to as a wide area antenna 35.

When the telephone call function is selected by the user via the operation buttons 23 or the touch panel 22, the central processing unit 30 shifts to a telephone call mode.

In this state, if a telephone number of a counterpart of the phone call is input by the user via the operation buttons 23 or the touch panel 22, and a calling order is subsequently input, the central processing unit 30 generates calling data with the use of the phone number.

In addition, the central processing unit 30 transmits the calling data from the wide area antenna 35 to the base station via the wide area communication processing unit 34.

In so doing, the central processing unit 30 transmits the calling data to a telephone device (not shown) of the counterpart via the wide area telephone line network and informs the counterpart of calling from the user via the telephone device.

As a result, if the counterpart permits the telephone call, and the communication connection with the telephone device of the counterpart is established, the central processing unit 30 collects sound of the user from a microphone 36, processes the obtained sound signal by a sound processing unit 37, and generate sound data for the telephone call.

Then, the central processing unit 30 transmits the sound data for the telephone call from the wide area antenna 35 to the base station via the wide area communication processing unit 34.

In so doing, the central processing unit 30 transmits the sound data for the telephone call of the user's sound to the telephone device of the counterpart via the wide area telephone line network.

In addition, when the sound data for the telephone call transmitted from the telephone device of the counterpart is received by the wide area antenna 35 at this time, the central processing unit 30 takes the sound data for the telephone call via the wide area communication processing unit 34 and sends the sound data for the telephone call to the sound processing unit 37.

The sound processing unit 37 processes the sound data for the telephone call given from the central processing unit 30 and outputs the obtained sound signal as sound of the counterpart from a speaker 38.

In so doing, when the communication connection with the telephone device of the counterpart is established in the telephone call mode in response to a telephone call request from the user, the central processing unit 30 can receive the sound data for the telephone call of the sound of both the user and the counterpart and allow the user and the counterpart to speak on the phones.

In addition, when call receiving data transmitted from the telephone device of the counterpart is received by the wide area antenna 35, the central processing unit 30 takes the call receiving data via the wide area communication processing unit 34 regardless of the function being executed.

Moreover, the central processing unit 30 outputs ring alert from the speaker 38, for example, based on the call receiving data and informs the user of the call received from the counterpart.

As a result, if the telephone call is permitted by the user via the operation buttons 23 or the touch panel 22, and the communication connection with the telephone device of the counterpart is established, the central processing unit 30 generates sound data for the telephone call by the microphone 36 and the sound processing unit 37 in the same manner as above.

In addition, the central processing unit 30 transmits the sound data for the telephone call from the wide area antenna 35 to the base station via the wide area communication processing unit 34.

In so doing, the central processing unit 30 transmits the sound data for the telephone call of the user's sound to the telephone device of the counterpart via the wide area telephone line network.

Moreover, when the sound data for the telephone call transmitted from the telephone device of the counterpart is received by the wide area antenna 35 at this time, the central processing unit 30 takes the sound data for the telephone call via the wide area communication processing unit 34 and sends the sound data for the telephone call to the sound processing unit 37.

The sound processing unit 37 processes the sound data for the telephone call given form the central processing unit 30 and outputs the obtained sound signal as the sound of the counterpart from the speaker 38.

In so doing, the central processing unit 30 can transmit and receive sound data for the telephone call of the sound of both the user and the counterpart and allow the user and the counterpart to speak on the phone even when the communication connection with the telephone device with the counterpart is established in response to the telephone call request from the counterpart.

Incidentally, if a sound data obtaining function is selected by the user via the operation buttons 23 or the touch panel 22, the central processing unit 30 shifts to a sound data obtaining mode.

At this time, if the obtaining of a sound selection page image is requested by the user via the operation buttons 23 or the touch panel 22, the central processing unit 30 generates page image request data.

In addition, the central processing unit 30 transits the page image request data from the wide area antenna 35 to the base station via the wide area communication processing unit 34 and transmits the page image request data to a distribution apparatus (not shown) on the Internet (not shown) via the base station.

As a result, when the page image data is replied from the distribution apparatus via the base station, the central processing unit 30 receives the page image data by the wide area antenna 35 and tales the page image data via the wide area communication processing unit 34.

Then, after the page image data is subjected to decoding processing by an image processing unit 40, the central processing unit 30 displays the page image data to the display 21 via the display processing unit 41.

In so doing, the central processing unit 30 displays the sound selection page image based on the page image data on the display surface 21A of the display 21.

If desired sound data is selected by the user on the sound selection page image via the operation buttons 23 or the touch panel 22 in this state, the central processing unit 30 generates sound request data for requesting the selected sound data in response thereto.

In addition, the central processing unit 30 transmits the sound request data from the wide area antenna 35 to the base station via the wide area communication processing unit 34 and sends the sound request data to the distribution apparatus on the Internet via the base station.

As a result, when the sound data selected by the user is transmitted along with the attribute data indicating attribute information of the sound data from the distribution apparatus via the base station, the central processing unit 30 receives them by the wide area antenna 35 and takes them via the wide area communication processing unit 34.

In addition, in the following description, the attribution information of the sound data will also be referred to as sound attribute information, and the attribute data indicating the sound attribute information will also be referred to as sound attribute data.

Then, the central processing unit 30 sends the sound data and the sound attribute data to a storage medium 42 built in or detachably provided on the mobile terminal 11, make correspondence relationship between the sound data and the sound attribute data, and stores the sound data and the sound attribute data in the storage medium 42.

In so doing, the central processing unit 30 can obtain the sound data with the use of the distribution apparatus every time the obtaining of the sound data is requested by the user.

Here, the sound data is generated by converting sound such as music, sound in nature (wave sound, sound of a stream, songs of birds and insects, and the like), comic storytelling, reading, and the like into digital data.

In addition, the sound attribute data indicates identification information with which the sound data can be individually identified and reproduction time and data size of the sound data as the sound attribute information of the corresponding sound data. Moreover, in the following description, the identification information of the sound data will also be referred to as sound identification information.

Moreover, the sound attribute data also indicates a title, an artist, a category, a year of release, and the like of the sound based on the sound data as the sound attribute information of the corresponding sound data.

Then, if the sound data reproduction function is selected by the user via the operation buttons 23 or the touch panel 22, the central processing unit 30 shifts to a sound data reproduction mode.

At this time, the central processing unit 30 reads a plurality of sound attribute data items from the storage medium 42. In addition, the central processing unit 30 generates sound selection image data for selecting reproduction target sound data based on the title, for example, included in the plurality of sound attribute data items.

Then, the central processing unit 30 transmits the sound selection image data to the display 21 via the display processing unit 41.

In so doing, the central processing unit 30 displays a sound selection image (not shown) based on the sound selection image data on the display surface 21A of the display 21.

In such a case, on the sound selection image, titles of sound based on the plurality of sound data items are arranged in a list, for example.

In so doing, the central processing unit 30 informs the user of the reproducible sound data as corresponding titles via the sound selection image.

If reproduction target sound data is selected as a title by the user on the sound selection image via the operation buttons 23 or the touch panel 22 in this state, the central processing unit 30 reads the selected sound data from the storage medium 42. Then, the central processing unit 30 transmits the sound data to the sound processing unit 37.

The sound processing unit 37 performs predetermined reproduction processing such as decoding processing on the sound data given from the central processing unit 30 and outputs the obtained sound signal as sound via the speaker, or headphone or the like which is not shown in the drawings.

In so doing, the central processing unit 30 can reproduce the sound data selected as a reproduction target by the user and allow the user to listen to the sound based on the sound data.

Incidentally, when an object imaging function is selected by the user via the operation buttons 23 or the touch panel 22, the central processing unit 30 shifts to an imaging mode.

At this time, the camera unit 45 receives imaging light L1, which has been reached from an imaging range including an object, by a light receiving surface of an imaging element 47 via an imaging optical system 46 including various optical elements as well as the aforementioned imaging lens 24.

In addition, such an imaging element 47 is configured by a CCD (Charge Coupled Device) image sensor, a CMOS (Complementary Metal Oxide Semiconductor) image sensor, or the like.

At this time, the central processing unit 30 adjusts a position, an aperture of a diaphragm, and the like of the focus lens as an optical element in the imaging optical system 46 by appropriately driving and controlling a motor (not shown) provided in the imaging optical system 46 via the driver 48.

In so doing, the central processing unit 30 automatically adjusts focusing and exposure for the imaging range including the object in the imaging optical system 46.

In addition, if zooming is instructed by the user via the operation buttons 23 or the touch panel 22 at this time, the central processing unit 30 drives and controls the motor provided in the imaging optical system 46 via the driver 48 in response thereto.

In so doing, the central processing unit 30 moves a zooming lens as an optical element along an optical axis in the imaging optical system 46 and adjusts zooming magnification so at so widen or narrow the imaging range.

In this state, the central processing unit 30 controls the imaging element 47. Accordingly, the imaging element 47 performs photoelectric conversion on the imaging light L1 received by the light receiving surface at a predetermined cycle under control by the central processing unit 30 and sequentially generates and sends to the camera processing unit 49 an analog photoelectric conversion signal in accordance with the imaging light.

The camera processing unit 49 performs predetermined analog processing such as amplification processing, noise reduction processing, and the like on the photoelectric conversion signal every time the photoelectric conversion signal is given from the imaging element 47 to generate an analog imaging signal.

In addition, the camera processing unit 49 generates digital imaging data by performing analog-to-digital conversion processing on the imaging signal every time the imaging signal is generated.

Moreover, the camera processing unit 49 performs digital processing for showing an imaging state such as shading correction processing, image downsizing processing in accordance with resolution of the display 21 A of the display 21, and the like on the imaging data and sends the imaging data, on which digital processing has been performed, to the display 21.

In so doing, the camera processing unit 49 displays a captured image based on the imaging data as a moving image on the display surface 21A of the display 21.

As described above, the camera processing unit 49 can allow the user to view the captured image displayed on the display surface 21A of the display 21 and check the imaging states of the object such as an imaging range, composition, focusing, and the like.

If taking a picture is instructed by the user via the operation buttons 23 or the touch panel 22 in this state, the central processing unit 30 controls the imaging element 47, the camera processing unit 49, and the image processing unit 40 for taking a picture.

In practice, the central processing unit 30 exposes the light receiving light with the imaging light L1 in the imaging element 47 at this time at a predetermined shutter speed for taking a picture.

Accordingly, the imaging element 47 performs photoelectric conversion on the imaging light, with which the light receiving surface is exposed, and generates and sends to the camera processing unit 49 a photoelectric conversion signal in accordance with the exposing imaging light.

After the same analog processing as that described above is performed on the photoelectric conversion signal given from the imaging element 47 to generate an imaging signal at this time, the camera processing unit 49 performs analog-to-digital conversion processing on the generated imaging signal to generate imaging data.

In addition, the camera processing unit 49 performs digital processing for taking a picture such as shading correction processing, image downsizing processing in accordance with resolution selected in advance for taking a picture, and the like on the imaging data to generate picture image data and sends the generated picture image data to the image processing unit 40.

When the picture image data is given from the camera processing unit 49, the image processing unit 40 performs compression coding processing based on a predetermined compression coding scheme on the picture image data and sends the picture image data to the central processing unit 30.

Incidentally, the image processing unit 40 performs contraction processing on the picture image data so as to thin out pixels to generate thumbnail image data as attribute information of the picture image data at this time and also sends the generated thumbnail image data to the central processing unit 30.

In addition, although the thumbnail image based on the thumbnail image data has a smaller size than that of the picture image based on the picture image data, the thumbnail image has substantially the same picture as that in the picture image.

Accordingly, the thumbnail image can be used as an index of the picture image which is an original for the generation of the thumbnail image. In addition, in the following description, the attribute information of the picture image data will also be referred to as picture attribute information.

When the picture image data and the thumbnail image data are given from the image processing unit 40, the central processing unit 30 generates picture attribute data indicating the picture attribute information of the picture image data based on Exif (Exchangeable image file format), for example.

In addition, the picture attribute data indicate identification information with which the picture image data can individually be identified and data size of the picture image data as the picture attribute information of the corresponding picture image data. Moreover, in the following description, the identification information of the picture image data will also be referred to as picture identification information.

In addition, the picture attribute data also indicates various kinds of information such as imaging conditions and the like when the picture of the object is taken as the picture attribute information of the corresponding picture image data and includes the thumbnail image data generated by the image processing unit 40 at this time as the picture attribute information.

In addition, the central processing unit 30 sends the picture image data to the storage medium 42 along with the picture attribute data, makes a correspondence relationship between the picture image data and the picture attribute data, and stores the picture image data and the picture attribute data in the storage medium 42.

In so doing, the central processing unit 30 can take a picture of the object and stores the picture image data obtained as a result in the storage medium 42.

Then, if a picture image reproduction function is selected by the user via the operation buttons 23 or the touch panel 22, the central processing unit 30 shifts to a picture reproduction mode.

At this time, the central processing unit 30 reads a plurality of picture attribute data items from the storage medium 42. In addition, the central processing unit 30 generates picture selection image data for selecting reproduction target picture image data based on the thumbnail image data included in the plurality of the picture attribute data items.

Then, the central processing unit 30 displays a picture selection image (not shown) based on the picture selection image data on the display surface 21A of the display 21 by sending the picture selection image data to the display 21 via the display processing unit 41.

In such a case, in the picture selection image, a plurality of thumbnail images is arranged in a matrix shape, for example. In so doing, the central processing unit 30 informs the user of the reproducible picture image data as corresponding thumbnail images via the picture selection image.

If reproduction target picture image data is selected by the user as a thumbnail image on the picture selection image via the operation buttons 23 or the touch panel 22 in this state, the central processing unit 30 reads the selected picture image data from the storage medium 42. In addition, the central processing unit 30 sends the picture image data to the image processing unit 40.

When the picture image data is given from the central processing unit 30, the image processing unit 40 displays a picture image based on the picture image data on the display surface 21A of the display 21 by decoding the picture image data and sending the picture image data to the display 21.

In so doing, the central processing unit 30 can reproduce the picture image data selected as the reproduction target by the user and allow the user to show the picture image based on the picture image data.

With such a configuration, in the case of the mobile terminal 11, a communication processing unit 50 and an antenna 51 used for communicating with the devices 12A to 12N in a wireless manner based on the aforementioned near-field wireless communication standard are provided.

Such a communication processing unit 50 is for performing predetermined transmission processing on data for transmission and performing predetermined receiving processing on data received by the antenna 51 based on the aforementioned near-field wireless communication standard.

In addition, the antenna 51 is for transmitting data, on which transmission processing has been performed by the communication processing unit 50, to the devices 12A to 12N and for receiving data transmitted from the devices 12A to 12N based on the aforementioned near-field wireless communication standard.

In addition, in the following description, the communication processing unit 50 used for communicating with the devices 12A to 12N based on the near-field wireless communication standard will also be referred to as a near-field communication processing unit 50.

In addition, in the following description, the antenna 51 used for communicating with the devices 12A to 12N in a wireless manner based on the near-field wireless communication standard will also be referred to as a near-field antenna 51.

Then, the central processing unit 30 can realize a communication connection function for establishing communication connection with the aforementioned devices 12A to 12N with the use of the near-field communication processing unit 50 and the near-field antenna 51 based on the communication connection program developed on the RAM 32.

In addition, if the communication connection with the devices 12A to 12N is established, the central processing unit 30 can also sequentially realize the data transmission receiving function for transmitting and receiving data to and from the devices 12A to 12N with the use of the near-field communication processing unit 50 and the near-field antenna 51 based on the communication connection program developed on the RAM 32.

Accordingly, the communication connection function realized by the central processing unit 30 will firstly be described later, and the data transmission and receiving function realized by the central processing unit 30 will then be described.

If the communication connection function is selected by the user via the operation buttons 23 or the touch panel 22, the central processing unit 30 shifts to a communication connection mode.

In such a case, the central processing unit 30 causes the camera unit 45 to operate in the same manner as in the aforementioned imaging mode in order to allow the user to take a picture of the communication target devices 12A to 12N and select one.

In so doing, the central processing unit 30 images a direction, in which the incidence plane of the imaging lens 24 is made to face, with the camera unit 45 and displays the captured image as a moving image on the display surface 21A of the display 21.

Then, if taking a picture is instructed by the user via the operation buttons 23 or the touch panel 22 in a state in which the incidence plane of the imaging lens 24 is made to face at least one of the devices 12A to 12N, the central processing unit 30 takes a picture of the devices 12A to 12N.

In so doing, the camera processing unit 49 generates picture image data of a picture image in which at least one of the devices 12A to 12N is photographed.

That is, the central processing unit 30 allows the user to perform selection by taking a picture of the communication target devices 12A to 12N in the communication connection mode.

However, it is not possible to know what kinds of devices 12A to 12N the devices 12A to 12N are only by taking a picture of the devices 12A to 12N.

Therefore, the camera processing unit 49 generates the picture image data and ten sends the picture image data not to the image processing unit 40 but to the central processing unit 30 under control of the central processing unit 30 at this time.

That is, the camera processing unit 49 sends the picture image data of the picture image in which the devices 12A to 12N are photographed to the central processing unit 30 at this time in order to specify the communication target devices 12A to 12N selected by the user taking a picture thereof.

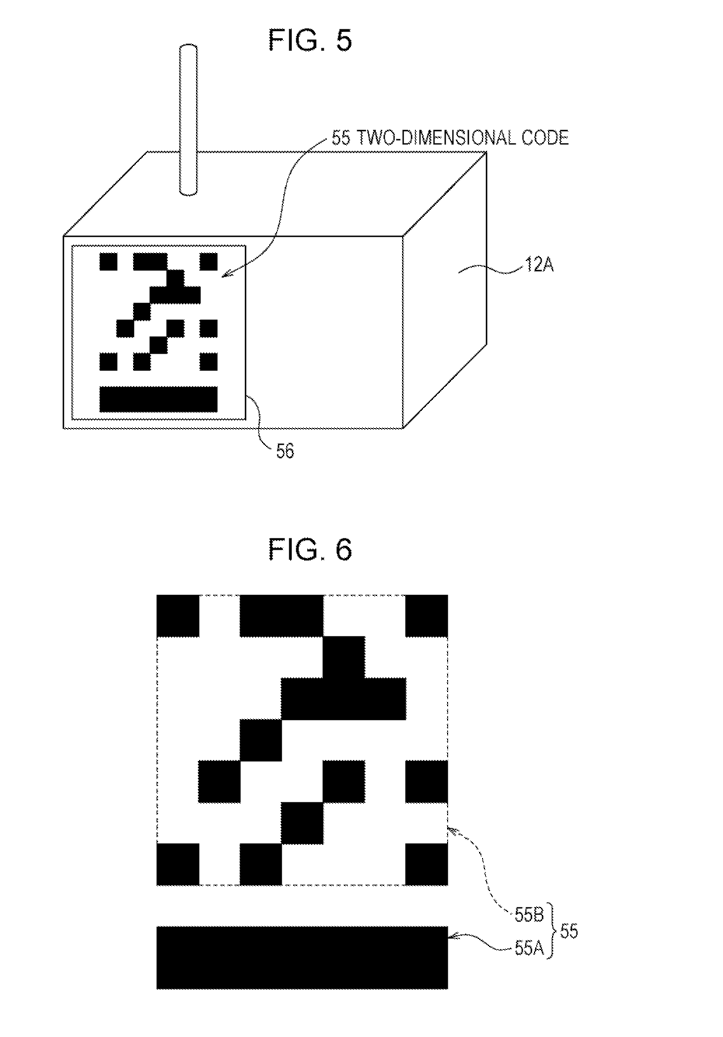

Here, as shown in FIG. 5, there are devices, onto which code stickers 56 with two-dimensional codes 55 called CyberCode (registered trademark) printed thereon, for example, are adhered on a front surface, a side surface, or the like which is relatively noticeable in the case body among the devices 12A to 12N.

In such a case, the two-dimensional code 55 is formed so as to code the identification information (hereinafter, this will also be referred to as device identification information), for example, of the devices 12A to 12N onto which the two-dimensional code 55 are adhered (that is, added as a code sticker 56).

As shown in FIG. 6, the two-dimensional code 55 is configured by a guide region 55A for indicating the location of the two-dimensional code 55 and a code region 55B in which a plurality of square cells as a minimum configuration unit is arranged in a matrix shape of n×m in the horizontal direction and the vertical direction.

The guide region 55A is formed in a rectangle shape having the same length as the length of one side of the code region 55B and arranged in parallel with a predetermined gap from the one side of the code region 55B.

In addition, in the code region 55B, a plurality of cells except for the cells at four corners respectively have one color among black and white, and the device identification information is expressed with the pattern of black and white of the plurality of cells.

In addition, in the two-dimensional code 55, the cells at the four corners of the code region 55B do not contribute to the expression of the device identification information, and black is always selected for detecting the code region 55B.

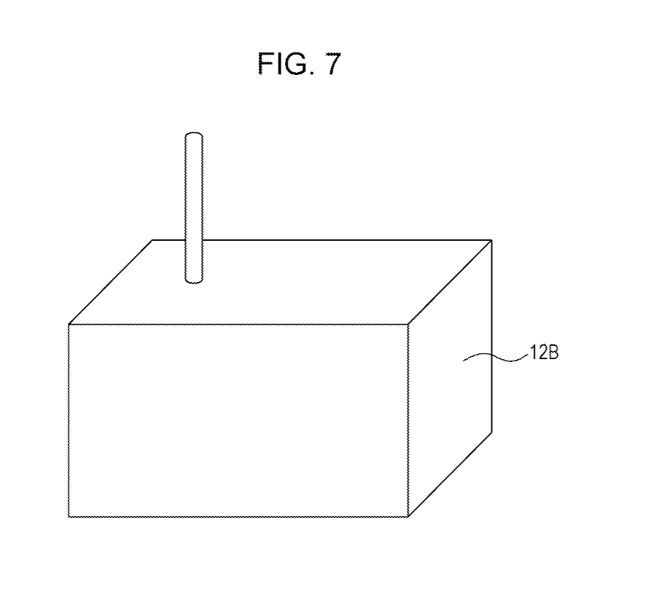

In addition, as shown in FIG. 7, there are devices with the case body, onto which no code sticker 56 with such a two-dimensional code 55 printed thereon is attached, among the devices 12A to 12N.

Moreover, the central processing unit 30 stores in the storage medium 42 the device information relating to the devices 12A to 12N for specifying the devices 12A to 12N and registers the device information in database (hereinafter, this will also be referred to as device database) constructed in the storage medium 42.

In such a case, the device information of the devices 12A to 12N is configured by attribute information of the devices 12A to 12N (hereinafter, this will also be referred to as device attribute information) and the communication usage information used by the mobile terminal 11 for communication with the devices 12A to 12N based on the near-field wireless communication standard, for example.

As the device attribute information, device identification information and model names of the corresponding devices 12A to 12N, device outline information indicating outlines of the devices 12A to 12N, icons generated as three-dimensional images schematically showing the devices 12A to 12N (hereinafter, this will also be referred to as device icons), and the like are exemplified.

As the communication usage information, a communication identifier called an SSID (Service Set Identifier) for the corresponding devices 12A to 12N and an encryption key called a WEP (Wired Equivalent Privacy) key used for encrypting transmission data and decoding received data are exemplified, for example.

In addition, as the communication usage information, encryption information indicating an encryption scheme of the transmission data, authentication information indicating an authentication scheme when the devices 12A to 12N authenticates the mobile terminal 11, and the like are exemplified.

Moreover, the device information of the devices 12A to 12N are registered in the device data base such that the device attribute information and the communication usage information are associated for each of the devices 12A to 12N.

In addition, the device identification information, the model names, the device outline information, and the like as the device attribute information are associated with each of the devices 12A to 12N on the device database.

Furthermore, the communication identifiers, the encryption keys, the encryption information, the authentication information, and the like as the communication usage information are also associated with each of the devices 12A to 12N on the device database.

Accordingly, when the picture image data is given from the camera processing unit 49, the central processing unit 30 specifies the devices 12A to 12N photographed in the picture image based on the picture image data with the use of the device database.

That is, the central processing unit 30 performs binarization processing on the picture image based on the picture image data at this time to generate a binary image and searches for the guide region 55A of the two-dimensional code 55 in the generated binary image.

As a result, when the guide region 55A of the two-dimensional code 55 is detected in the binary image, the central processing unit 30 detects the cells at the four corners of the code region 55B based on the position of the detected guide region 55A.

In so doing, the central processing unit 30 specifies the code region 55B based on the detected cells at the four corners in the binary image.

In addition, after the pattern of the plurality of black and white cells except for the cells at the four corners in the code region 55B within the binary image is converted into binary digit in a predetermined order in accordance with the positions of the guide region 55A and the cells at the four corners, the central processing unit 30 decodes the binary digit to generate device identification information.

In so doing, if the two-dimensional code 55 is photographed in the picture image along with the devices 12A to 12N, the central processing unit 30 detects the device identification information of the device 12A to 12N expressed by the two-dimensional code 55 based on the two-dimensional code 55.

Then, if the device identification information is detected from the picture image as described above, the central processing unit 30 detects the model names of the devices 12A to 12N photographed in the picture image with the use of the device database in the storage medium 42.

In so doing, when the devices 12A to 12N onto which the code stickers 56 are adhered are photographed in the picture image, the central processing unit 30 can specify the devices 12A to 12N (namely, the model names of the devices 12A to 12N).

In addition, the central processing unit 30 searches for a mass of edges which can be assumed to form outlines of the devices 12A to 12N without the code sticker 56 adhered thereto based on the shapes of the plurality of edges, the positional relationships of the plurality of edges, and the colors in the picture image.

Moreover, in the following description, the mass of the edges which can be assumed to form the outlines of the devices 12A to 12N will also be referred to as an assumed outline.

As a result, if the assumed outlines are detected in the picture image, the central processing unit 30 extracts the detected assumed outlines from the picture image.

Then, the central processing unit 30 reads the device outline information registered in the device database from the storage medium 42 and executes predetermined computation processing based on the outlines shown by the read device outline information and the assumed outlines.

In so doing, the central processing unit 30 calculates degrees of certainty indicating to what extent the assumed outlines are likely to be correct as the outlines of the devices 12A to 12N photographed in the picture image.

In addition, the central processing unit 30 compares the calculated degrees of certainty with a threshold value selected in advance. If the degrees of certainty are equal to or greater than the threshold value as a result, the central processing unit 30 estimates that the assumed outlines are outlines of the devices 12A to 12N photographed in the picture image.

Moreover, if the calculated degrees of certainty are less than the threshold value, the central processing unit 30 determines that the assumed outlines are not outlines of the devices 12A to 12N.

In so doing, the central processing unit 30 detects the assumed outlines with the degrees of certainty equal to or greater than the threshold value as outlines of the devices 12A to 12N photographed in the picture image.

Then, when the outlines of the devices 12A to 12N are detected in the picture image as described above, the central processing unit 30 detects the model names of the devices 12A to 12N photographed in the picture image with the use of the device database in the storage medium 42 based on the device outline information which has been used for the detection thereof.

In so doing, the central processing unit 30 can specify the devices 12A to 12N (namely, the model names of the devices 12A to 12N) even when the devices 12A to 12N without the code stickers 56 attached thereto are photographed in the picture image.

In so doing, the central processing unit 30 can specify the communication target devices 12A to 12N selected by taking a picture by the user regardless of whether or not the code stickers 56 have been attached to the devices 12A to 12N.

In addition, the central processing unit 30 can specify all devices 12A to 12N photographed in the picture image at this time even when a picture of the communication target communication target devices 12A to 12N is taken with the rest of the devices 12A to 12N due to a positional relationship in the setting.

Then, when the devices 12A to 12N photographed in the picture image are specified, the central processing unit 30 detects photographed positions of the devices 12A to 12N within the picture image (hereinafter, this will also be referred to as in-picture device positions).

That is, if the code stickers 56 have been attached to the specified devices 12A to 12N, the central processing unit 30 detects, for example, central positions of the two-dimensional codes 55 printed on the code stickers 56 in the picture image as in-picture device positions of the devices 12A to 12N.

In addition, if the coed stickers 56 have not been attached to the specified devices 12A to 12N, the central processing unit 30 detects, for example, central positions of the outlines of the devices 12A to 12N in the picture image as the in-picture device positions of the devices 12A to 12N.

In addition, in the following description, one side of the picture image in the image vertical direction will also be referred to as an upper side, and the other side will also be referred to as a lower side.

Moreover, in the following description, one side of the picture image in the image horizontal direction will also be referred to as a left side, and the other side will also be referred to as a right side.

Then, the central processing unit 30 sets, for example, a vertex at the left lower corner as an origin of a two-dimensional coordinate system, sets an axis passing through the origins and coincident with the lower side as an X axis, sets an axis passing through the origins and coincident with the left side as a Y axis, and detects the in-picture device positions as two-dimensional coordinates (XY coordinates).

Incidentally, in the storage medium 42, a conversion table for converting a distance from the incidence plane of the imaging lens 24 to a focused position within the imaging range (also referred to as a focus distance) into a distance within a three-dimensional spatial image expressing the imaging range is stored.

In addition, in the following description, one side of a plane on the side of the imaging lens 24 in the three-dimensional spatial image expressing the imaging range in the vertical direction will also be referred to as an upper side, and the other side of the plane in the vertical direction will also be referred to as a lower side.

Moreover, in the following description, one side of the plane on the side of the imaging lens 24 in the three-dimensional spatial image in the horizontal direction will also be referred to as a left side, and the other side of the plane in the horizontal direction will also be referred to as a right side.

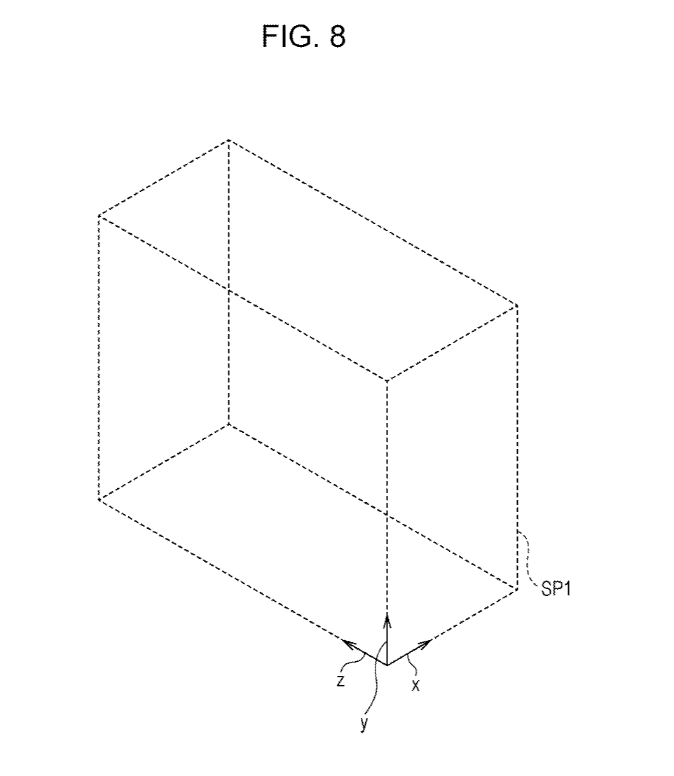

In such a case, as shown in FIG. 8, the plane on the side of the imaging lens 24 in the three-dimensional spatial image SP1 expressing the imaging range has the same size and shape as those of the aforementioned picture image and is formed in a rectangular parallelpiped shape.

In addition, in the three-dimensional spatial image SP1, the vertex at the left lower corner in the plane on the side of the imaging lens 24 is set as the origin of the three-dimensional coordinate system.

Moreover, in the three-dimensional spatial image SP1, an axis passing through the origin and coincident with the lower side of the plane on the imaging lens 24 is set as an X axis, an axis passing through the origin and coincident with the left side of the plane on the side of the imaging lens 24 is set as a Y axis, and an axis passing through the origin and coincident with the lower side of the plane on the left side is set as a Z axis.

In addition, in the following description, the plane on the side of the imaging lens 24 in the three-dimensional spatial image SP1 will also be referred to as an XY plane.

Therefore, the aforementioned conversion table is generated by using a position of a focusing lens (also referred to as a focusing lens position), for example, as the focus distance and associating the Z coordinate as a distance in the three-dimensional spatial image SP1 corresponding to the focus distance with the focusing position.

Accordingly, when the in-picture device positions are detected, the central processing unit 30 searches for the Z coordinates corresponding to the focusing lens positions in the conversion table based on the focusing lens positions at the time of focusing in taking the picture of the devices 12A to 12N.

In addition, the central processing unit 30 adds the searched Z coordinates to the XY coordinates representing the in-picture device positions to obtain a three-dimensional coordinates (XYZ coordinates) representing positions of the devices 12A to 12N in the three-dimensional spatial image SP1 expressing the imaging range (hereinafter, this will also be referred to as in-space device positions).

Moreover, the central processing unit 30 reads device icons of the specified devices 12A to 12N, which have been registered in the device database, from the recording medium 42.

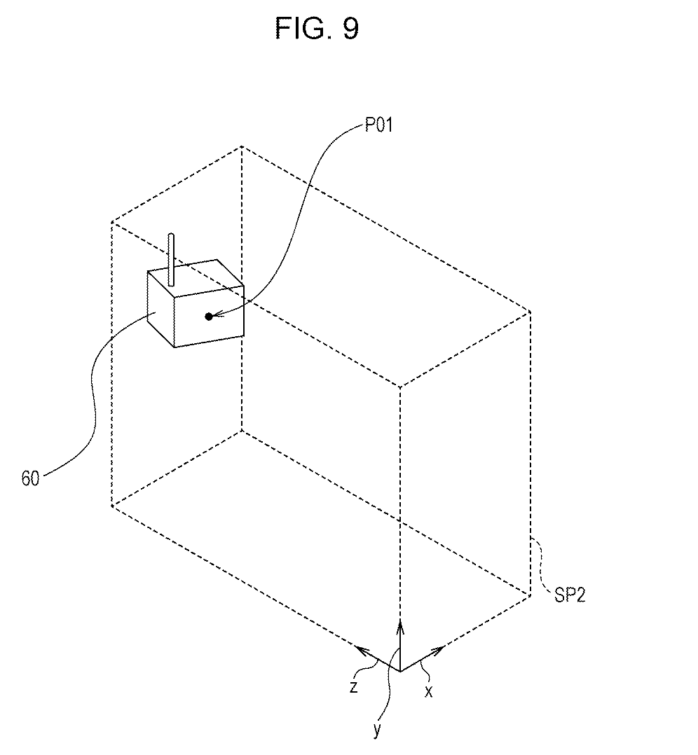

Then, as shown in FIG. 9, the central processing unit 30 generates a three-dimensional spatial image SP2 in which the device icons 60 are arranged in the in-space device position PO1 so as to show the imaging range at this time in a three-dimensional manner with the devices 12A to 12N arranged within the imaging range.

In addition, the central processing unit 30 extracts imaged posture information indicating imaged postures of the specified devices 12A to 12N from the picture image at this time.

For example, if the code stickers 56 have been adhered to the specified devices 12A to 12N, the central processing unit 30 extracts vectors showing imaged shapes of the two-dimensional codes 55 as imaged posture information from the picture image.

In addition, if the code stickers 56 have not been adhered to the specified devices 12A to 12N, the central processing unit 30 extracts vectors showing imaged shapes of the outlines of the devices 12A to 12N as the imaged posture information from the picture image.

Then, the central processing unit 30 arranges the device icons 60 at the spatial device positions so as to match with the postures at the time of taking the picture of the devices 12A to 12N based on the imaged posture information and generates the three-dimensional spatial image SP2.

In addition, the central processing unit 30 converts the three-dimensional spatial image SP2 into a two-dimensional plane image by projecting the three-dimensional spatial image SP2 onto a two-dimensional plane as is viewed from a closer side than the XY plane to the side of the XY plane (that is, as is viewed from a view point in front of the XY plane to the side of the XY plane while a line of sight is maintained in parallel to the Z axis).

In so doing, the central processing unit 30 generates a selected device image indicating the devices 12A to 12N selected by the user as a two-dimensional plane image and sends the selected device image data of the selected device image to the display 21 via the display processing unit 41.

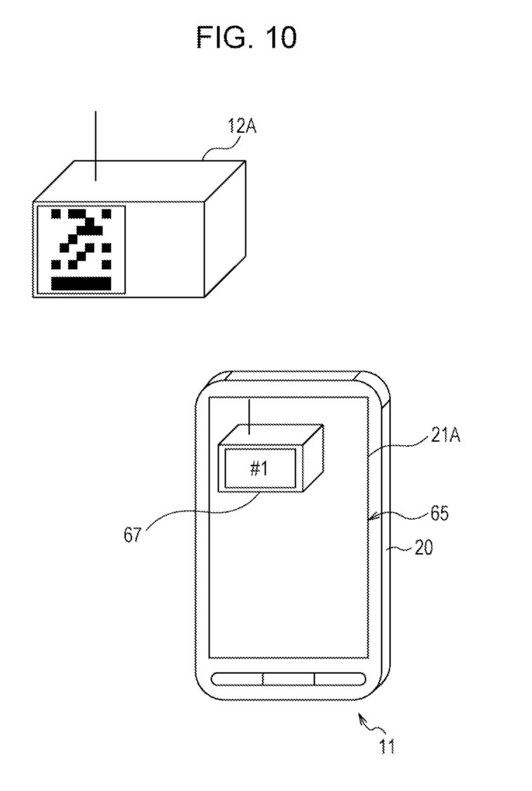

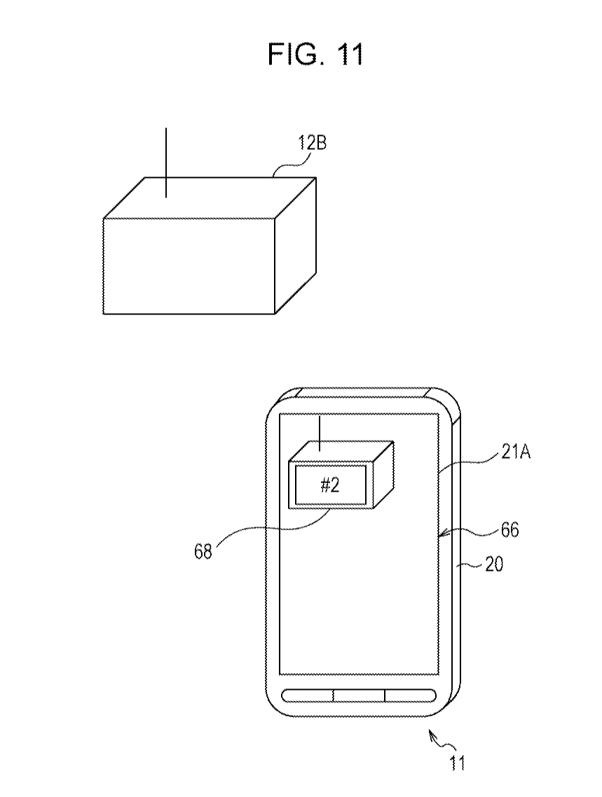

In so doing, when a picture of only one device 12A or 12B is taken at this time, the central processing unit 30 displays the selected device image 65 or 66 as shown in FIG. 10 or 11 on the display surface 21A of the display 21 based on the selected device image data.

That is, the central processing unit 30 displays the selected device image 65 or 66 which informs with the device icon 67 or 68 of only one device 12A or 12B selected by the user as a communication target, on the display 21A of the display 21.

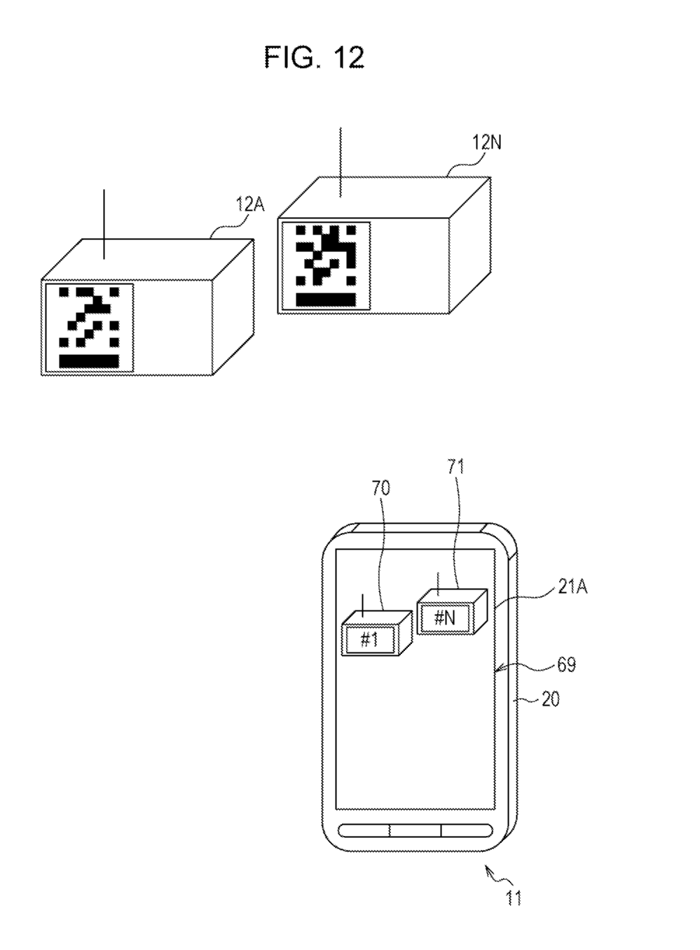

In addition, when a picture of two devices 12A and 12N is taken at this time, for example, the central processing unit 30 displays the selected device image 69 as shown in FIG. 12 on the display surface 21A of the display 21 based on the selected device image data.

That is, the central processing unit 30 displays the selected device image 69 which informs with the device icons 70 and 71 one device 12A selected by the user as the communication target and the other device 12N photographed together in the picture image, on the display surface 21A of the display 21.

When the selected device images 65, 66, or 69 is displayed on the display surface 21A on the display 21, the central processing unit 30 starts search processing for searching for the communication target devices 12A to 12N selected by the user.

However, when only one of the devices 12A to 12N is shown in the selected device image 65 or 66, the central processing unit 30 regards the one of the devices 12A to 12N as a communication target and automatically starts the search processing in accordance with the display of the selected device image 65 or 66.

In addition, when a plurality of (two, for example) devices 12A and 12N are shown in the selected device image 69, the central processing unit 30 waits for reselection of one of the devices 12A and 12N as a communication target on the selected device image.

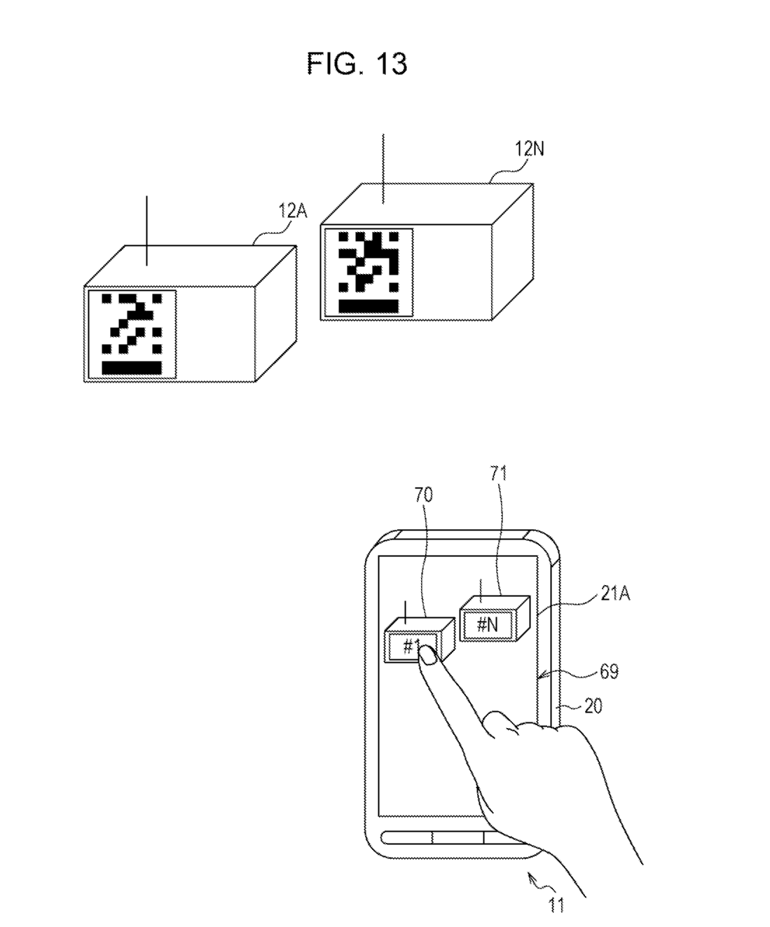

Then, as shown in FIG. 13, when one communication target device 12A is reselected as a device ion 70 by a tapping operation by the user on the selected device image 69, for example, the central processing unit 30 starts the search processing in response thereto.

When the search processing is started, the central processing unit 30 searches for the communication usage information of the communication target among devices 12A to 12N (namely, the communication usage information corresponding to the model name of the specified one of the devices 12A to 12N) in the device database in the storage medium 42.

In addition, the central processing unit 30 reads the communication usage information searched for from the storage medium 42, stores the communication identifier read as the communication usage information, and generates a search signal for searching for the communication target among the devices 12A to 12N.

Then, the central processing unit 30 transmits the search signal from the near-field antenna 51 via the near-field communication processing unit 50.

Here, the devices 12A to 12N maintains the same communication usage information of the devices 12A to 12N as the communication usage information stored in the storage medium 42 in the aforementioned mobile terminal 11 (that is, the communication identifiers, the encryption keys, and the like of the devices 12A to 12N).

In addition, the devices 12A to 12N receive the search signals transmitted from the mobile terminal 11 during the operation. Then, when a search signals is received, each of the devices 12A to 12N compares the communication identifier stored in the search signal with the communication identifier maintained in itself to determine whether or not the two communication identifiers are coincident with each other.

As a result, the two communication identifiers are coincident with each other, each of the devices 12A to 12N replies to the mobile terminal 11 a search response signal representing that the searched one of the devices 12A to 12N is itself (that is, that the device is present in an operating state).

In addition, at this time, even the device among the devices 12A to 12N which has been searched for by the mobile terminal 11 (namely, the communication target) cannot receive the search signal and does not reply the search response signal in a state in which an operation is stopped.

In addition, the devices 12A to 12N which have not been searched for by the mobile terminal 11 do not reply the search response signal even when the search signal is received during the operation since the communication identifier stored in the search signal does not coincide with the communication identifiers maintained in themselves.

Accordingly, when the search signal is transmitted, the central processing unit 30 waits for the reply of the search response signal from the communication target among the devices 12A to 12N.

Then, if the search response signal is not replied from the communication target among the devices 12A to 12N even when the search signal is transmitted, the central processing unit 30 determines that the device among the one of the devices 12A to 12N stops the operation and that it is not possible to make communication connection and completes the search processing and the communication connection processing.

In addition, when the search response signal replied from the communication target among the devices 12A to 12N is received by the near-field antenna 51 and taken via the near-field communication processing unit 50, the central processing unit 30 recognizes by the search response signal that the communication target among the devices 12A to 12N could be found.

That is, the central processing unit 30 recognizes from the search response signal that the communication target among the devices 12A to 12N in a state in which communication connection is available.

In so doing, the central processing unit 30 completes the search processing and subsequently starts the authentication processing based on an authentication scheme indicated by the authentication information as the communication usage information.

That is, when the communication target among the devices 12A to 12N is operating and can be searched for (that is, it is possible to confirm that communication is available), the central processing unit 30 starts the authentication processing for communication connection.

When the authentication processing is started, the central processing unit 30 transmits a start request signal, for example, which is for requesting the communication target among the devices 12A to 12N to start the authentication, to the communication target among the devices 12A to 12N from the near-field antenna 51 via the near-field communication processing unit 50.

At this time, when the start request signal transmitted from the mobile terminal 11 is received after the reply of the search response signal to the mobile terminal 11, the communication target among the devices 12A to 12N starts the authentication processing based on the authentication scheme indicated by the authentication information as the communication usage information, for example.

Then, when the authentication processing is started, the communication target among the devices 12A to 12N stores a random number to generate a start response signal for responding to the start of the authentication processing and replies the generated start response signal to the mobile terminal 11.

If the start response signal is replied from the communication target among the devices 12A to 12N as a result of the transmission of the start request signal to the communication target among the devices 12A to 12N, the central processing unit 30 receives the start response signal by the near-field antenna 51 and takes the start response signal via the near-field communication processing unit 50.

In addition, the central processing unit 30 encrypts the random number stored in the start response signal with the use of the encryption key as the communication usage information, for example, to generate an encrypted random number.

Then, the central processing unit 30 stores the encrypted random number to generate an authentication request signal for requesting authentication and transmits the generated authentication request signal from the near-field antenna 51 to the communication target among the devices 12A to 12N via the near-field communication processing unit 50.

At this time, when the authentication request signal transmitted from the mobile terminal 11 is received after the reply of the start response signal to the mobile terminal 11, the communication target among the devices 12A to 12N extracts the encrypted random number from the authentication request signal.

In addition, the communication target among the devices 12A to 12N generates a random number by decoding the encrypted random number with the use of an encryption key maintained in itself.

Then, the communication target among the devices 12A to 12N compares the generated random number with the random number transmitted to the mobile terminal 11 at this time to determine whether or not the two random numbers are coincident with each other.

If the two random numbers are coincident with each other as a result, the communication target among the devices 12A to 12N authenticates the mobile terminal 11 as an official communication counterpart and replies an authentication response signal indicating the authentication result to the mobile terminal 11.

If the authentication response signal is replied from the communication target among the devices 12A to 12N as a result of the transmission of the authentication request signal to the communication target among the devices 12A to 12N, the central processing unit 30 receives the authentication response signal by the near-field antenna 51 and takes the authentication response signal via the near-field communication processing unit 50.

In so doing, the central processing unit 30 recognizes based on the authentication response signal that the mobile terminal 11 has been authenticated by the communication target among the devices 12A to 12N, completes the authentication processing, and subsequently starts communication setting processing.

When the communication setting processing is started, the central processing unit 30 generates a setting request signal for requesting the communication target among the devices 12A to 12N to perform various kinds of setting for communication.

Then, the central processing unit 30 transmits the setting request signal to the communication target among the devices 12A to 12N from the near-field antenna 51 via the near-field communication processing unit 50.

At this time, if the setting request signal transmitted from the mobile terminal 11 is received after the reply of the authentication response signal to the mobile terminal 11, the communication target among the devices 12A to 12N performs various kinds of setting for communication with the mobile terminal 11 in response to the setting request signal.

Then, when the setting is completed, the communication target among the devices 12A to 12N replies to the mobile terminal 11 a permission response signal for permitting communication.

If a permission response signal is replied from the communication target among the devices 12A to 12N as a result of the transmission of the setting request signal to the communication target among the devices 12A to 12N, the central processing unit 30 receives the permission response signal by the near-field antenna 51 and takes the permission response signal via the near-field communication processing unit 50.

In so doing, the central processing unit 30 recognizes based on the permission response signal that the communication has been permitted by the communication target among the devices 12A to 12N, that is, the communication connection with the communication target among the devices 12A to 12N has been established and completes the setting request processing and the communication connection processing.

In so doing, the central processing unit 30 establishes the communication connection between the mobile terminal 11 and the communication target among the devices 12A and 12N by executing the communication connection processing.

Incidentally, in the mobile terminal 11, informing levels for informing a progress situation in a stepwise manner in accordance with the progress situation of the communication connection processing during the execution of the communication connection processing are selected in advance.

In practice, total of five levels of the informing levels are selected including transmission timing of the search signal in the search processing, transmission timing of the start request signal in the authentication processing, transmission timing of the authentication request signal in the authentication processing, transmission timing of the setting request signal in the communication setting processing, and establishment timing of the communication connection, for example.

Then, the central processing unit 30 updates the progress situation informing image for each informing level in accordance with the progress situation of the communication connection processing such that the progress situation informing image for informing the progress situation of the communication connection processing with the selected device image 65, 66, or 69, during the execution of the communication connection processing.

In so doing, the central processing unit 30 informs the user of the progress situation of the communication connection processing with the progress situation informing image synthesized with the selected device image 65, 66, or 69.

However, the central processing unit 30 generates the selected device image 65, 66, or 69 based on the three-dimensional spatial image SP2 as described above.

Therefore, the central processing unit 30 synthesizes the progress situation informing image with the selected device image 65, 66, or 60 such that the progress situation informing image is arranged in the three-dimensional spatial image SP2 as an original of the selected device image 65, 66, or 69 in practice.

Here, the progress situation informing processing for informing of the progress situation of the communication connection processing, which is executed as a part of the communication connection processing by the central processing unit 30, will specifically be described.

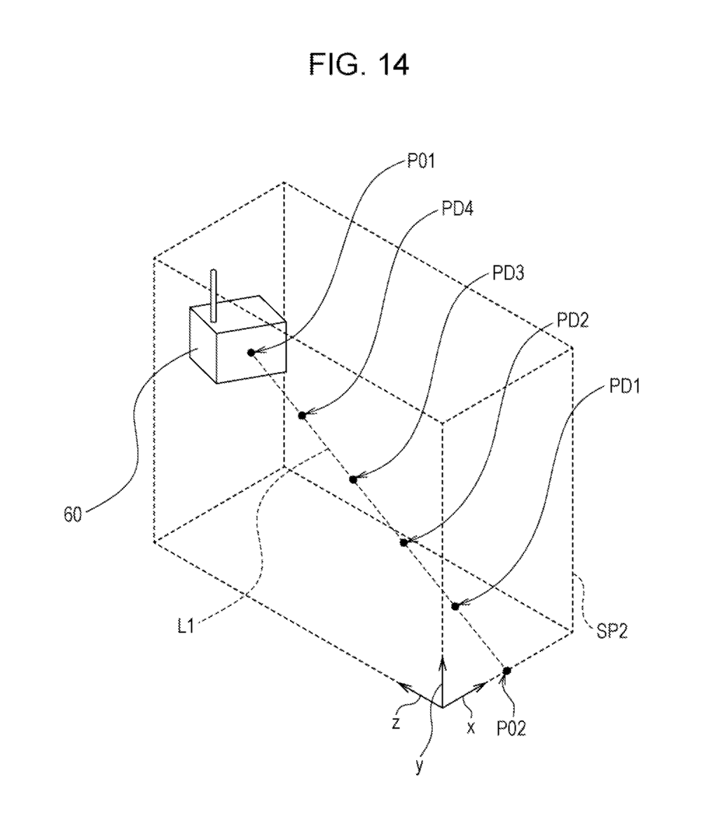

As shown in FIG. 14, when the imaged device 12B is specified and the three-dimensional spatial image SP2 is generated, for example, the central processing unit 30 sets a midpoint on the lower side of the XY plane as a position P02 of the mobile terminal 11 (hereinafter, this will also be referred to as a terminal position).

In addition, the central processing unit 30 detects individual division positions PD1 to PD4 so as to equally divide an inter-position line segment L1 connecting the terminal position P02 and the in-space device position P01 by the number of the aforementioned informing levels in the three-dimensional spatial image SP2.

In addition, in the following description, the plurality of division positions PD1 and PD4 on the inter-position line segment L1 will also be referred to as a first division position PD1 to a fourth division position PD4 in an order from the side of the terminal position P02.

Then, when the search processing is started, and the search signal is transmitted to the communication target device 12B, the central processing unit 30 starts synthesis of the progress situation informing image of an isosceles triangle, for example, with respect to the selected device image 66.

In addition, in the following description, the vertex at the apex angle part in the progress situation informing image of the isosceles triangle will also be referred to as an end of the image, and a base will also be referred to as the other end of the image.

Moreover, in the following description, a length from a midpoint on the other end of the image (namely, a midpoint of the base of the isosceles triangle) to one end of the image (namely, the vertex at the apex angle of the isosceles triangle) in the progress situation informing image of the isosceles triangle will also be referred to as an image length.

In such a case, for the progress situation informing image, only the length of the other end of the image is selected in advance. Therefore, the central processing unit 30 selects the image length of the progress situation informing image for every informing level in accordance with the progress situation of the communication connection processing and generates the progress situation informing image based on the length of the other end of the image and the selected image length.

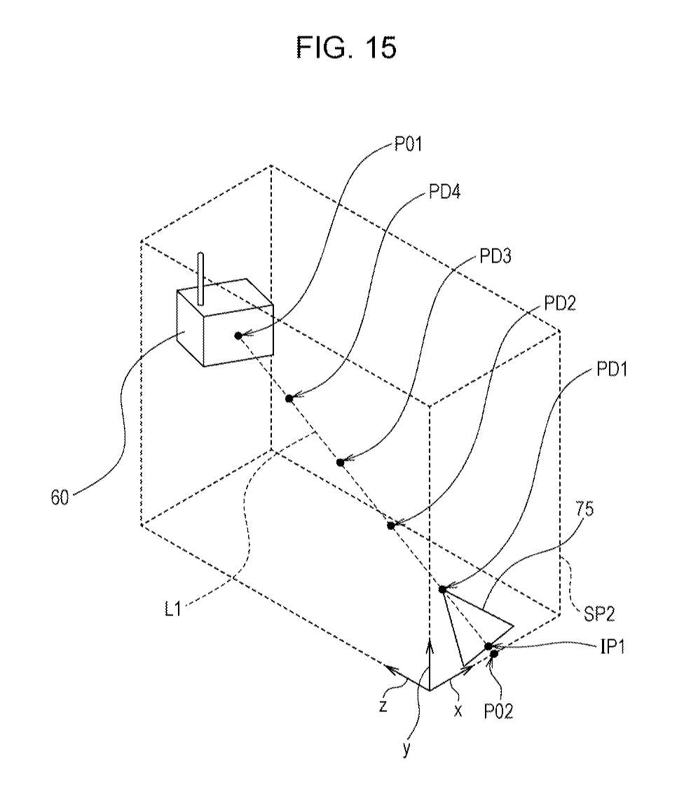

Accordingly, as shown in FIG. 15, the central processing unit 30 sets the inter-position line segment L1 in the three-dimensional spatial image SP2 as a midperpendicular line of the progress situation informing image 75 and detects an intersection point IP1 between the other end of the image and the inter-position line segment L1 at the time of bringing the other end of the image to be in contact with the X axis at least at one point. In addition, in the following description, the intersection point IP1 between the other end of the image and the inter-position line segment L1 will also be referred to as a line segment intersection point IP1.

Moreover, the central processing unit 30 selects (that is, detects) a distance from the line segment intersection point IP1 to the first division position PD1 on the inter-position line segment L1 of the three-dimensional spatial image SP2 as the image length of the progress situation informing image 75.

Furthermore, the central processing unit 30 generates the progress situation informing image 75 based on the length of the other end of the image selected in advance and the image length selected at this time.

Then, the central processing unit 30 arranges the progress situation informing image 75 in the three-dimensional spatial image SP2 such that the midpoint of the other end of the image is made to coincide with the line segment intersection point IP1 of the inter-position line segment L1 and one end of the image is made to coincide with the first division position PD1.

As described above, the central processing unit 30 processes the three-dimensional spatial image SP2 so as to be capable of informing of the progress situation of the communication connection processing.

In addition, the central processing unit 30 converts the three-dimensional spatial image SP2 into a selected device image configured as a two-dimensional plane image by projecting the three-dimensional spatial image SP2 onto a two-dimensional plane in the same manner as described above.

Then, the central processing unit 30 sends the selected device image data of the selected device image to the display 21 via the display processing unit 41.

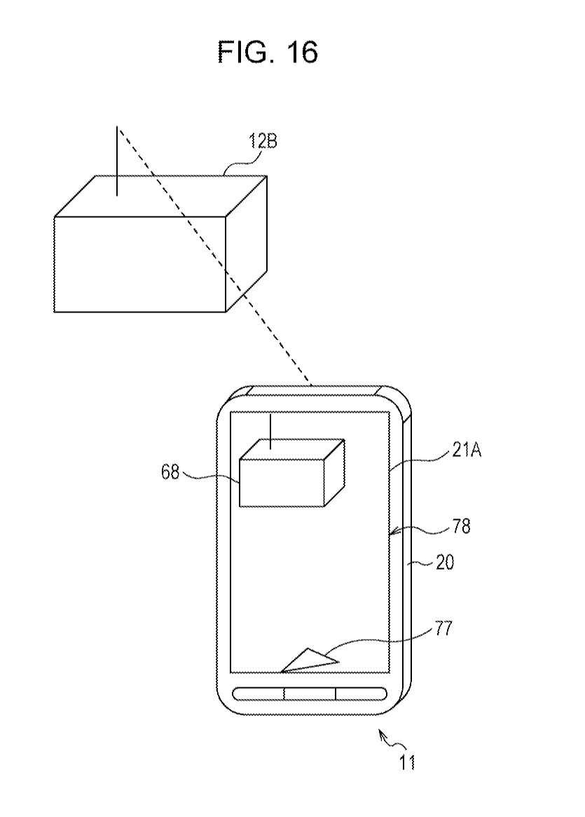

In so doing, the central processing unit 30 displays the selected device image 78 in which the progress situation information image 77 is synthesized as shown in FIG. 16 on the display surface 21A of the display 21 based on the selected device image data.

Thereafter, when the authentication processing is started, and the start request signal is transmitted to the communication target device 12B, the central processing unit 30 generates the progress situation informing image again.

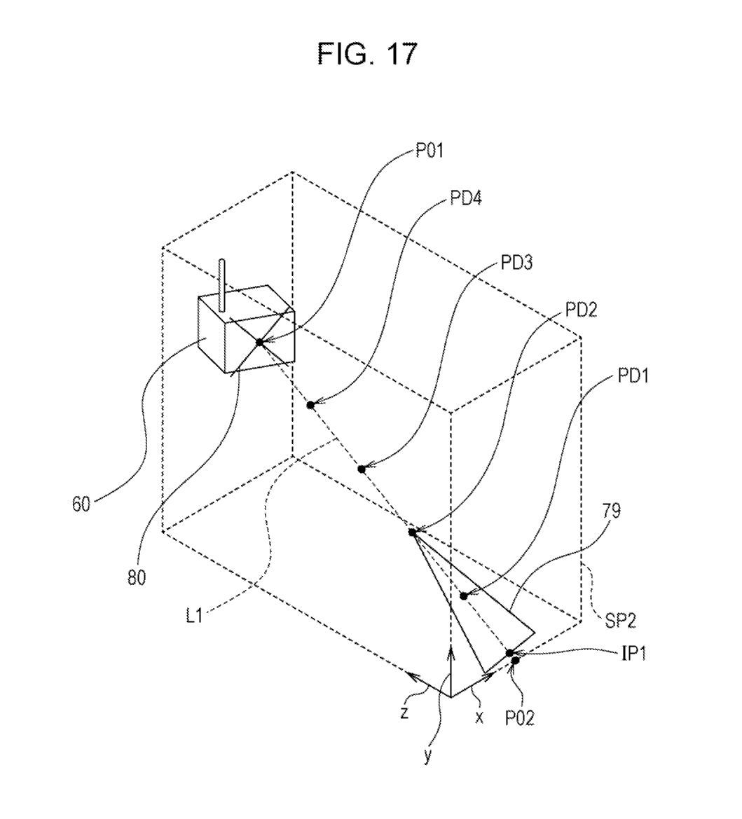

That is, as shown in FIG. 17, the central processing unit 30 selects a distance from the line segment intersection point IP1 to the second division position PD2 on the inter-position line segment L1 of the three-dimensional spatial image SP2 as the image length of the progress situation informing image 79.

Accordingly, the central processing unit 30 generates a new progress situation informing image 79 which is longer as a whole than the previously generated progress situation informing image 75 based on the length of the other end of the image selected in advance and the image length selected at this time.

Then, the central processing unit 30 arranges the progress situation informing image 79 in the three-dimensional spatial image SP2 such that the midpoint of the other end of the image is made to coincide with the line segment intersection point IP1 of the inter-position line segment L1 and the one end of the image is made to coincide with the second division position PD2.

In addition, the central processing unit 30 processes the three-dimensional spatial image SP2 at this time after finding the communication target device 12B in a state in which communication connection is available in the previous search processing.

Therefore, the central processing unit 30 attaches a device finding mark 80 such as an “x” mark, for example, indicating that the communication target device 12B in a state in which the communication connection is available has been found to the device icon 60 in the three-dimensional spatial image SP2 so as to be seen from the side of the XY plane.

Thereafter, the central processing unit 30 converts the three-dimensional spatial image SP2 into a selected device image configured as a two-dimensional plane image by projecting the three-dimensional spatial image SP2 onto a two-dimensional plane in the same manner as described above.

Then, the central processing unit 30 sends the selected device image data of the selected device image to the display 21 via the display processing unit 41.

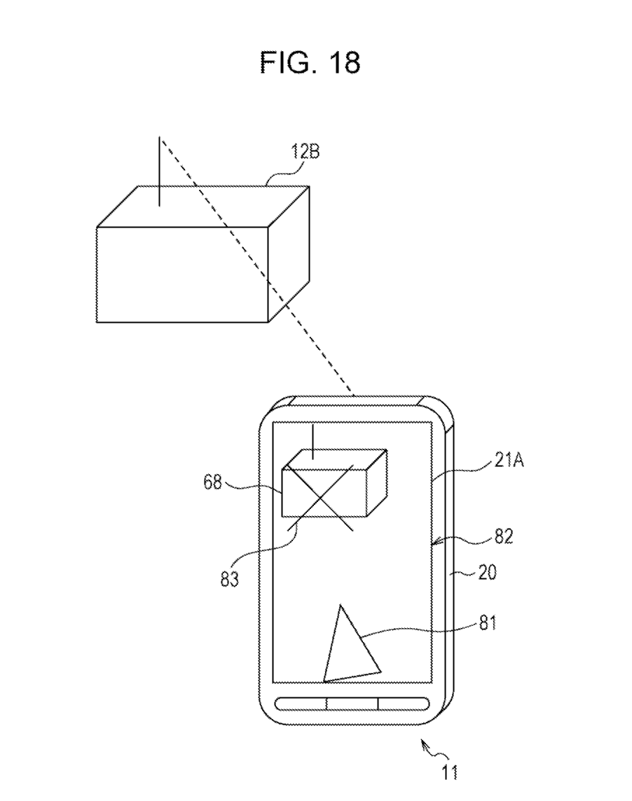

In so doing, the central processing unit 30 displays the selected device image 82 in which the progress situation informing image 81 is synthesized as shown in FIG. 18 on the display surface 21A of the display 21 based on the selected device image data.

That is, the central processing unit 30 updates the progress situation informing image 81 in the selected device image 82 to be displayed on the display surface 21A of the display 21 at this time such that the entirety is extended and one end of the image is brought to be further closer to the device icon 68 while the other end of the image is fixed.

Therefore, the central processing unit 30 can allow the user to intuitively recognize that the communication connection processing for communication connection of the mobile terminal 11 with the communication target device 12B is properly proceeding, by the updated progress situation informing image 81.

In addition, the central processing unit 30 can also allow the recognition of that the connection processing through a line is being continued after finding the communication target device 12B in a state in which the communication is available, with the device finding mark 83 attached to the device icon 68 in the selected device image 82.

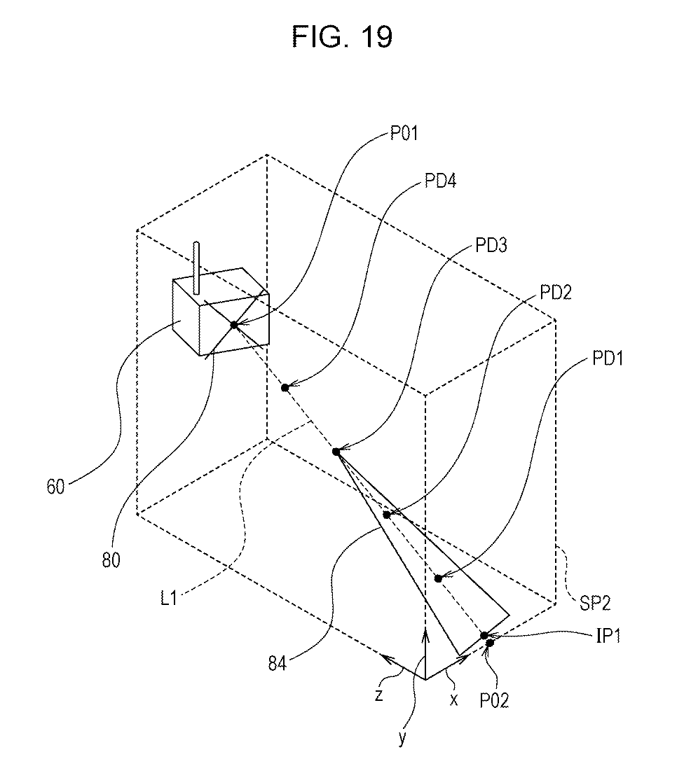

Moreover, as shown in FIG. 19, when the authentication request signal is transmitted to the communication target device 12B, the central processing unit 30 selects as an image length a distance from the line segment intersection point IP1 to the third division position PD3 on the inter-position line segment L1 of the three-dimensional spatial image SP2.

Then, the central processing unit 30 generates a further longer new progress situation informing image 84 as a whole than the previously generated progress situation informing image 79 based on the length of the other end of the image and the selected image length.

In addition, the central processing unit 30 arranges the new progress situation informing image 84 in the three-dimensional spatial image SP2 such that the midpoint of the other end of the image is made to coincide with the line segment intersection point IP1 of the inter-position line segment L1 and one end of the image is made to coincide with the third division position PD3.

Moreover, the central processing unit 30 generates a selected device image based on the three-dimensional spatial image SP2 in the same manner as described above and sends the selected device image data of the selected device image to the display 21 via the display processing unit 41.

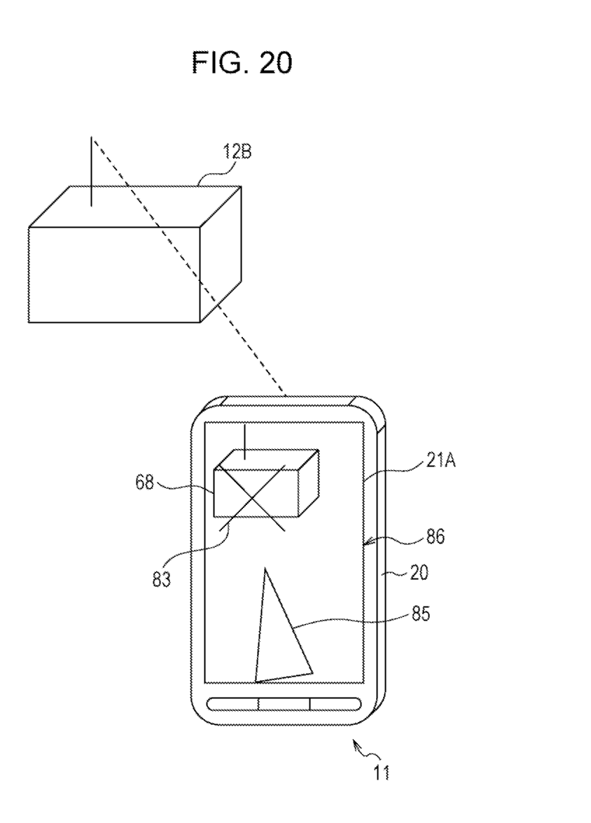

In so doing, the central processing unit 30 displays the selected device image 86 in which the progress situation informing image 85 is synthesized on the display surface 21A of the display 21 as shown in FIG. 20 based on the selected device image data.

That is, the central processing unit 30 updates the progress situation informing image 85 in the selected device image 86 to be displayed on the display surface 21A of the display 21 at this time such that the entirety is extended to bring one end of the image to be further closer to the device icon 68 while the other end of the image is fixed.

Accordingly, the central processing unit 30 can allow the user to intuitively recognize by the updated progress situation informing image 85 that the communication connection processing has further proceeded.

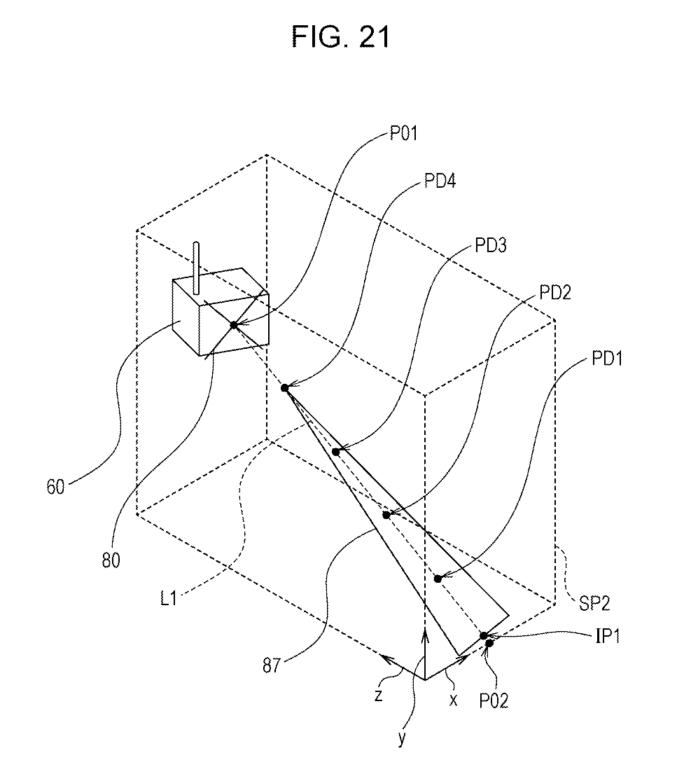

Furthermore, as shown in FIG. 21, when the communication setting processing is started, and the setting request signal is transmitted to the communication target device 12B, the central processing unit 30 selects as the image length a distance from the line segment intersection point IP1 to the fourth division position PD4 on the inter-position line segment L1 of the three-dimensional spatial image SP2.

Then, the central processing unit 30 generates a further longer new progress situation informing image 87 as a whole than the previously generated progress situation informing image 84 based on the length of the other end of the image and the selected image length.

In addition, the central processing unit 30 arranges the new progress situation informing image 87 in the three-dimensional spatial image SP2 such that the midpoint of the other end of the image is made to coincide with the line segment intersection point IP1 of the inter-position line segment L1 and one end of the image is made to coincide with the fourth division position PD4.

Moreover, the central processing unit 30 generates the selected device image based on the three-dimensional spatial image SP2 in the same manner as described above and sends the selected device image data of the selected device image to the display 21 via the display processing unit 41.

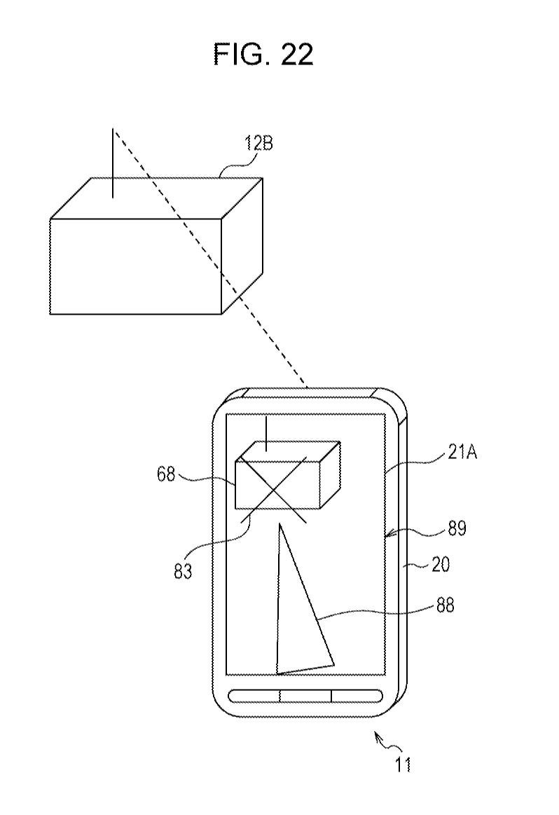

In so doing, the central processing unit 30 displays the selected device image 89 in which the progress situation informing image 88 is synthesized as shown in FIG. 22 on the display surface 21A of the display 21 based on the selected device image data.

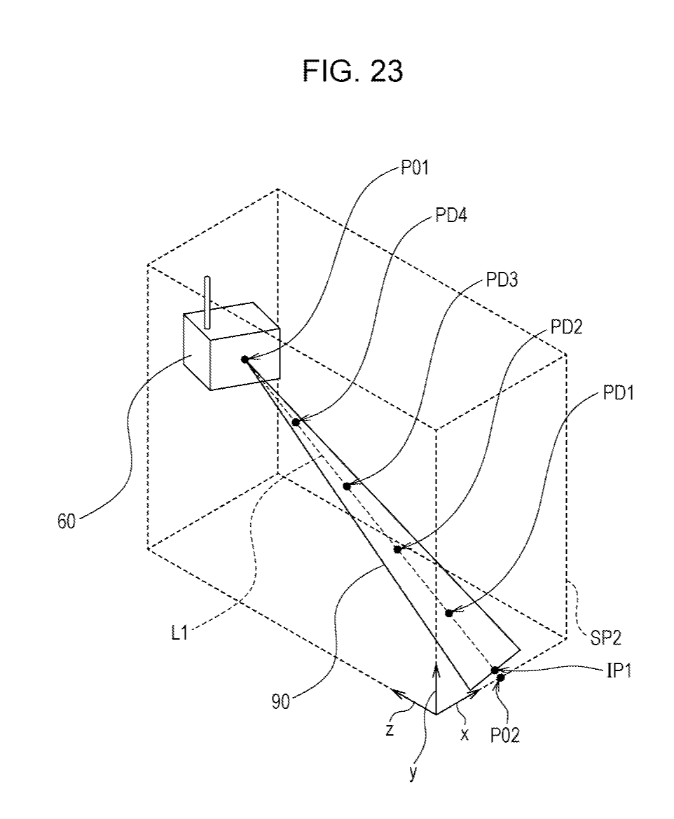

Then, as shown in FIG. 23, when the communication connection with the communication target device 12B is established, the central processing unit 30 selects as the image length a distance from the line segment intersection point IP1 to the inter-space device position P01 on the inter-position line segment L1 of the three-dimensional spatial image SP2.

Then, the central processing unit 30 generates a further longer new progress situation informing image 90 as a whole than the previously generated progress situation informing image 87 based on the length of the other end of the image and the selected image length.

In addition, the central processing unit 30 arranges the new progress situation informing image 90 in the three-dimensional spatial image SP2 such that the midpoint of the other end of the image is made to coincide with the line segment intersection point IP1 of the inter-position line segment L1 and one end of the image is made to coincide with the in-space device position P01.

In addition, if the communication connection with the communication target device 12B is established at this time, the central processing unit 30 deletes the device finding mark 80 attached to the device icon 60 in the three-dimensional spatial image SP2.

Moreover, the central processing unit 30 generates a selected device image based on the three-dimensional spatial image SP2 in the same manner as described above and sends the selected device image data of the selected device image to the display 21 via the display processing unit 41.

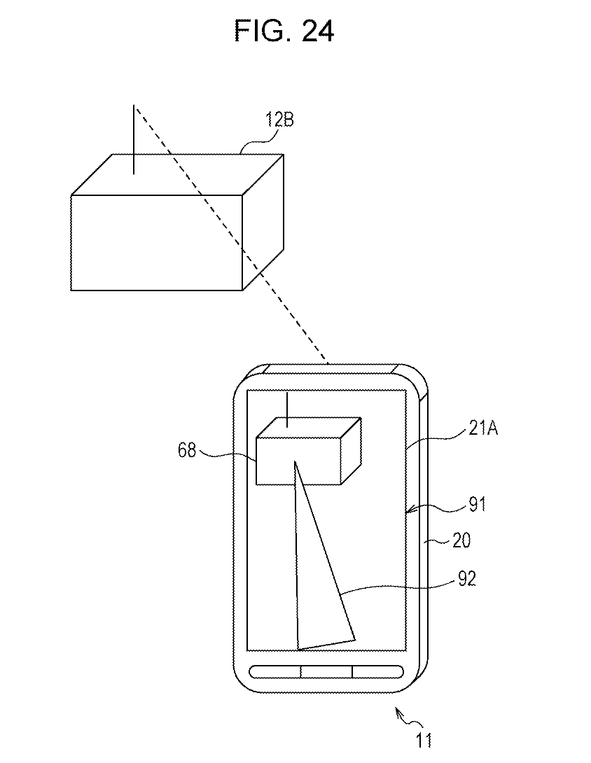

In so doing, when the communication connection with the communication target device 12B is established, the central processing unit 30 finally updates the progress situation informing image 92 by displaying a selected device image 91 as shown in FIG. 24 on the display surface 21A of the display 21.

That is, when the communication connection with the communication target device 12B is established, the central processing unit 30 updates the progress situation informing image 92 to be synthesized with the selected device image 91 such that one end of the image of the progress situation informing image 92 is brought to be in contact with the device icon 68.

In so doing, the central processing unit 30 updates the progress situation informing image to be synthesized with the selected device image in accordance with the progress situation of the communication connection processing such that the entirety is sequentially extended to gradually cause one end of the image to be closer to the device icon 68 while the other end of the image is fixed.

According, the central processing unit 30 can allow intuitive recognition of that the processing for connecting the mobile terminal 11 with the connection target device 12B is properly proceeding by the update of the progress situation informing image.

In addition, when the communication connection with the communication target device 12B is established as the progress situation of the communication connection processing, the central processing unit 30 performs update such that one end of the image of the progress situation information image 92 to be synthesized with the selected device image 91 is finally connected to the device icon 68.

Therefore, the central processing unit 30 can allow intuitive recognition of that the communication connection has been established as if the mobile terminal 11 was connected in a wired manner to the communication target device 12B, by the final update of the progress situation informing image 92.

In addition, when the communication target device 12B stops the operation and cannot receive the search response signal, for example, even if the search processing is executed and the search signal is transmitted, for example, the central processing unit 30 processes the selected device image data in response thereto.

Then, the central processing unit 30 sends the processed selected device image data to the display 21 via the display processing unit 41.

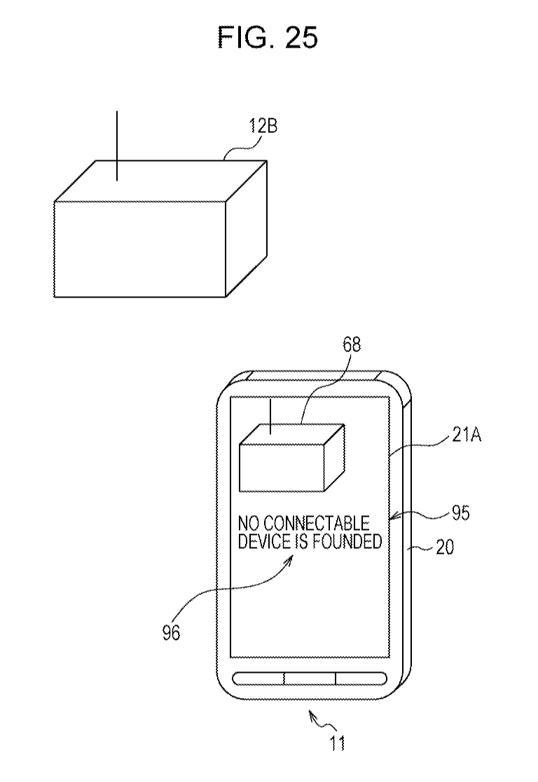

In so doing, the central processing unit 30 displays the selected device image 95 as shown in FIG. 25 based on the selected device image data on the display surface 21A of the display 21.

That is, the central processing unit 30 overlaps a text 96 of “no connectable device has been found”, for example, which represents that the communication target device 12B could not be searched for, on the selected device image 95 at this time.

In so doing, the central processing unit 30 can inform the user of that the communication target device 12B stops the operation and it is not possible to make communication connection, via the text 96 on the selected device image 95.

In so doing, the central processing unit 30 automatically selects a data transmission receiving function in a sequential manner and moves on to the data transmission receiving mode when the communication connection with the communication target device 12B has been established and a state in which data transmission and receiving are available has been obtained.

At this time, if transmission of picture image data is requested by the user via the operation buttons 23 or the touch panel 22, for example, the central processing unit 30 reads a plurality of picture attribute data items from the storage medium 42.

In addition, the central processing unit 30 synthesizes thumbnail image data included in the plurality of picture attribute data items and sends the obtained selected device synthesized image data to the display 21 via the display processing unit 41.

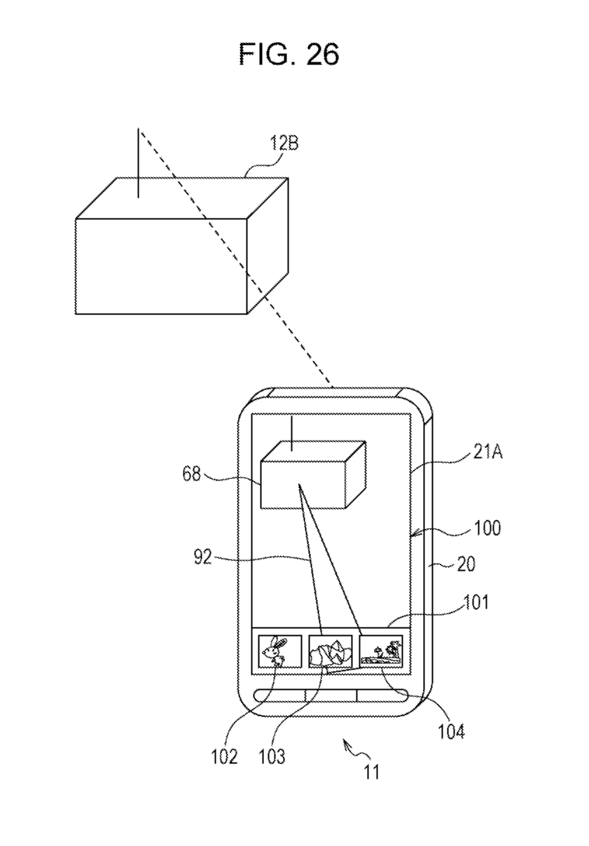

In so doing, the central processing unit 30 displays the selected device synthesized image 100 as shown in FIG. 26 based on the selected device synthesized image data on the display surface 21A of the display 21.

The selected device synthesized image 100 is provided with a thumbnail display region 101 near the lower end of the original selected device image, a plurality of thumbnail images 102 to 104 are disposed within the thumbnail display region 101 so as to be arranged in a line in the image horizontal direction.

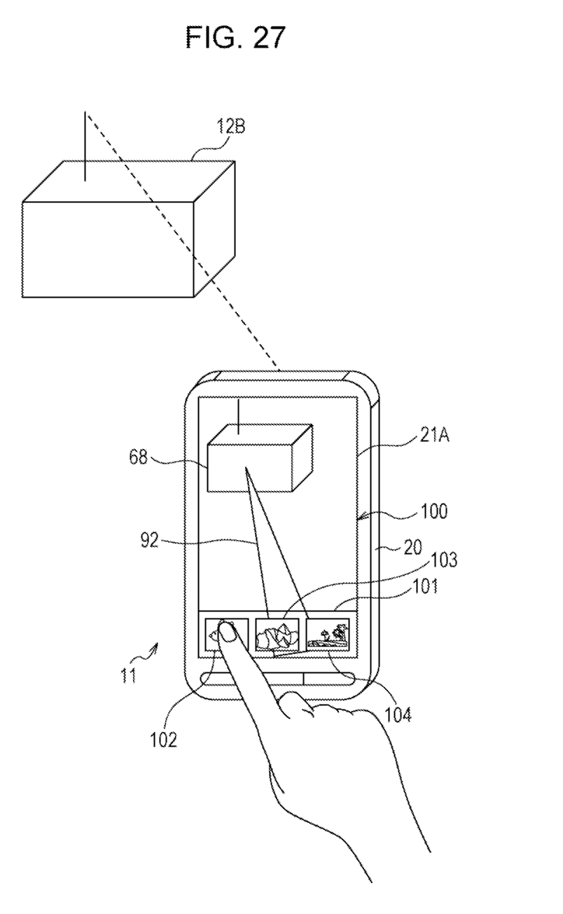

At this time, as shown in FIG. 27, when a tapping operation is performed on the thumbnail image 102 by the user, for example, the central processing unit 30 recognizes that picture image data corresponding to the thumbnail image 102, on which the tapping operation has been performed, has been selected as a transmission target.

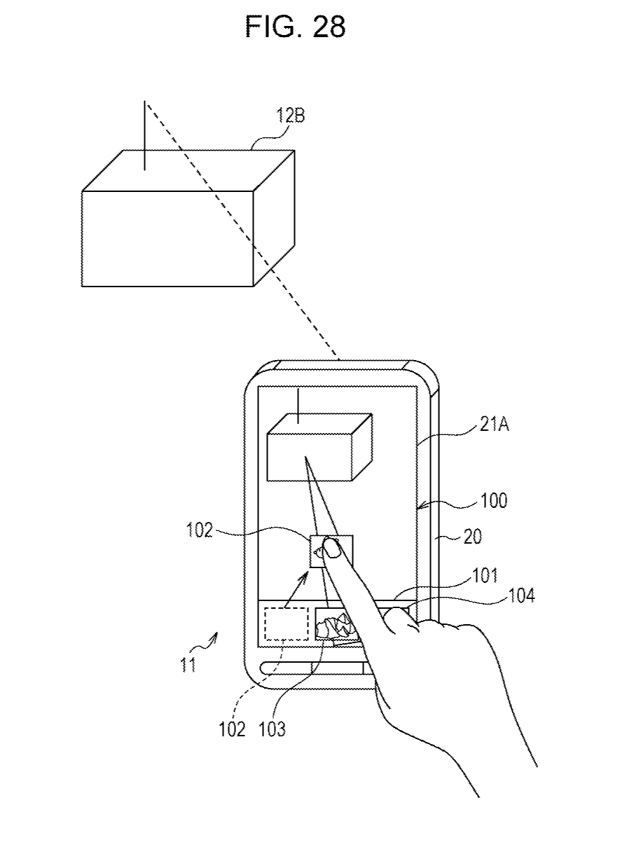

In addition, as shown in FIG. 28, when a tip end of a finger is placed on the thumbnail image 102 by the user and a sliding operation is performed, for example, the central processing unit 30 drags (moves) the thumbnail image 102 to the movement destination of the tip end of the finger in the sliding operation.

Then, when the thumbnail image 102 is dragged from the inside of the thumbnail display region 101 onto the progress situation informing image 92 in accordance with the sliding operation, the central processing unit 30 recognizes that picture image data corresponding to the dragged thumbnail image 102 has been selected as a transmission target.

In so doing, when the transmission target picture image data is selected as the corresponding thumbnail image 102, the central processing unit 30 reads the selected picture image data from the storage medium 42.

Then, the central processing unit 30 transmits the picture image data to the communication target device 12B (namely, the device 12B for which the communication connection has been established) from the near-field antenna 51 via the near-field communication processing unit 50.

Incidentally, the central processing unit 30 sequentially transmits the transmission target picture image data, for example, in predetermined units of data which is significantly smaller than the data size at this time.

In addition, while transmitting the transmission target picture image data in predetermined units of data, the central processing unit 30 sequentially detects the data size of the transmitted part.

Furthermore, while transmitting the transmission target picture image data in predetermined units of data, the central processing unit 30 sequentially detects a rate of the transmitted part and a rate of a part which has not yet been transmitted with respect to the entire picture image data based on the data size of the transmitted part and the data size of the entire picture image data.

In addition, in the following description, the rate of the transmitted part with respect to the entire picture image data will also be referred to as a transmitted rate, and the rate of the part, which has not yet been transmitted, with respect to the entire picture image data will also be referred to as a non-transmitted rate.

Then, the central processing unit 30 informs of the progress situation of the transmission processing of the transmission target picture image data on the selected device image, for example, based on the transmitted rate and the non-transmitted rate.

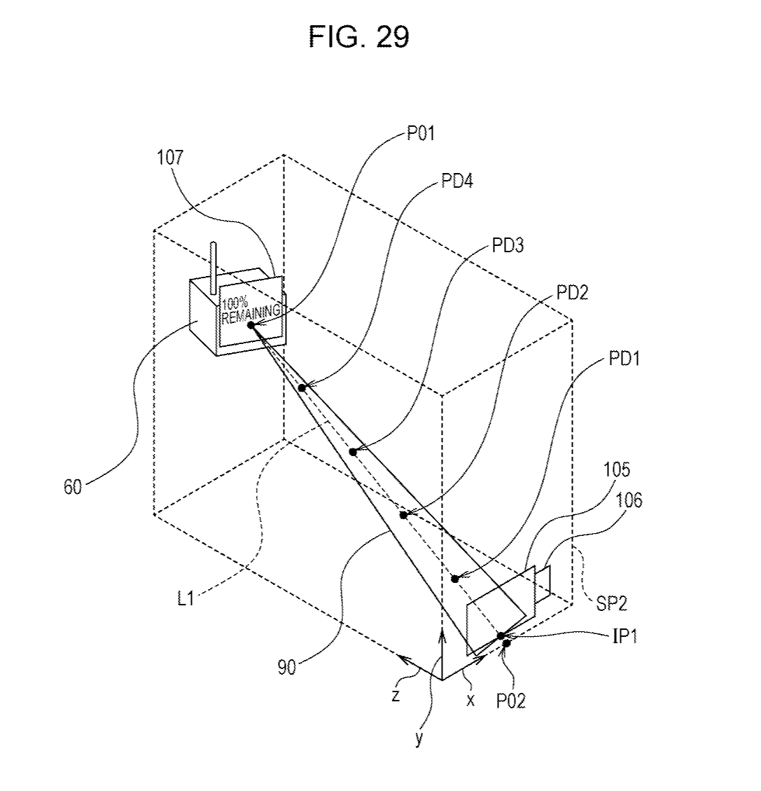

As shown in FIG. 29, when the transmission target picture image data is selected in practice, the central processing unit 30 processes (expand or contract) the thumbnail image 102, for example, so as to be wider than the width of a root part of the progress situation informing image 90 within the three-dimensional spatial image SP2.

Moreover, the central processing unit 30 arranges the thumbnail image 105 obtained by processing in the three-dimensional spatial image SP2 so as to be parallel to the XY plane such that the midpoint of the lower side is made to coincide with the line segment intersection point IP1.

That is, the central processing unit 30 arranges the thumbnail image 105 at the root part of the progress situation informing image 90 such that the thumbnail image 105 indicating the transmission target picture image data can be seen from the side of the XY plane.

In addition, the central processing unit 30 describes a text (“0%”, for example) showing the transmitted rate of the transmission target picture image data at the right side of the thumbnail image 105 in the three-dimensional spatial image SP2 and also arranges a generated transmitted rate informing image 106 such that the background is permeable.

Moreover, the central processing unit 30 attaches a non-transmitted rate informing image 107 in which a text(“100% remaining”, for example) indicating the non-transmitted rate of the transmission target picture image data is described, for example, to the device icon 60 in the three-dimensional spatial image SP2 so as to be seen from the side of the XY plane.

Then, the central processing unit 30 converts the three-dimensional spatial image SP2 in to the selected device image configured by a two-dimensional plane image by projecting the three-dimensional spatial image SP2 on a two-dimensional plane in the same manner as described above.

In addition, the central processing unit 30 sends the selected device image data of the selected device image to the display 21 via the display processing unit 41.

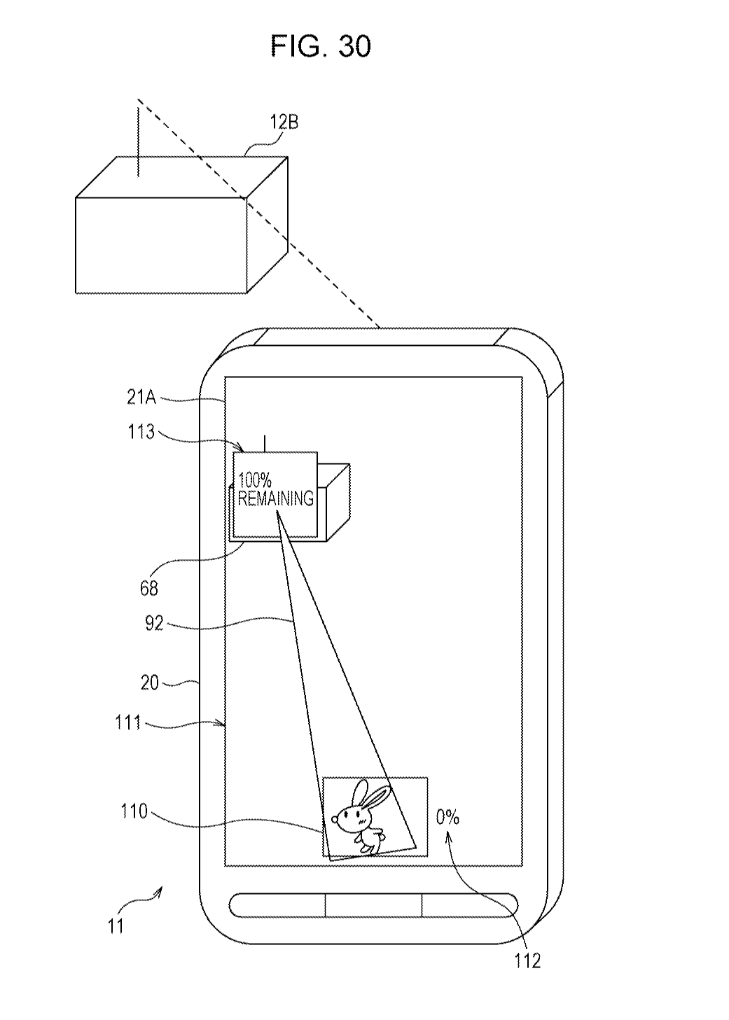

In so doing, the central processing unit 30 displays the selected device image 111 representing the transmission target picture image data as the thumbnail image 110 as shown in FIG. 30 on the display surface 21A of the display 21 based on the selected device image data.

In such a case, the central processing unit 30 can allow intuitive recognition of that transmission of the picture image data shown by the thumbnail image 110 will be started, by the arrangement position of the thumbnail image 110 on the progress situation informing image 92 in the selected device image 111.

In addition, the central processing unit 30 can allow confirmation of that transmission of the picture image data will be started, by the text 112 on the right of the thumbnail image 110 or the non-transmitted rate informing image 113 attached to the device icon 68 in the selected device image 111.

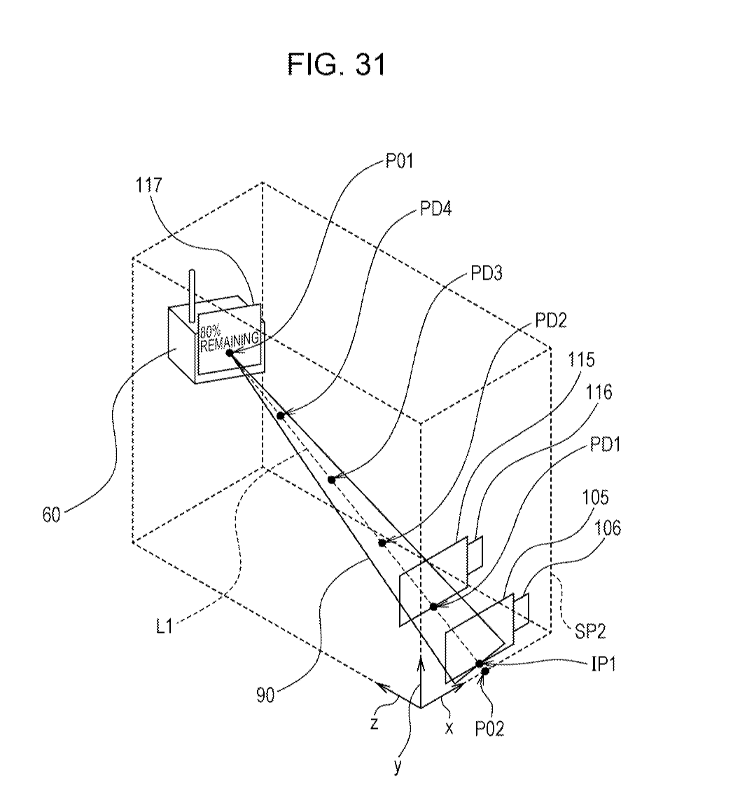

In addition, as shown in FIG. 31, when the transmitted rate reaches 20%, for example, the central processing unit 30 processes (expands or contracts) the thumbnail image 102 so as to be slightly wider than the width of the first division position PD1 of the progress situation informing image 90 in the three-dimensional spatial image SP2.

Moreover, the central processing unit 30 arranges the thumbnail image 115 in the previously generated three-dimensional spatial image SP2 so as to be parallel with the XY plane such that the midpoint of the lower side is made to coincide with the first division position PD1, by adding the processed thumbnail image 115.

That is, the central processing unit 30 additionally arranges the thumbnail image 115 indicating the transmission target picture image data so as to be closer to the device icon 60 than the root part of the progress situation informing image 90 so as to be seen from the side of the XY plane.

In addition, the central processing unit 30 describes a text (“20%”, for example) indicating the transmitted rate of the transmission target picture image data on the right side of the thumbnail image 115 in the three-dimensional spatial image SP2 and also arranges the generated transmitted rate informing image 116 such that the background is permeable.

Moreover, the central processing unit 30 changes the non-transmitted rate informing image 107 attached to the device icon 60 in the three-dimensional spatial image SP2 to the non-transmitted rate informing image 117 in which a text (“80% remaining”, for example) indicating the non-transmitted rate at this time is described.

Then, the central processing unit 30 converts the three-dimensional spatial image SP2 into a selected device image configured by a two-dimensional plan image by projecting the three-dimensional spatial image SP2 onto a two-dimensional plane in the same manner as described above.

In addition, the central processing unit 30 processes the thumbnail image 105 previously arranged in the three-dimensional spatial image SP2 at this time such that the background is slightly permeable.

In addition, the central processing unit 30 sends the selected device image data of the selected device image to the display 21 via the display processing unit 41.

Moreover, the central processing unit 30 then adds the thumbnail image with the transmitted rate informing image to the three-dimensional spatial image SP2 in the same manner as described above every time the transmitted rate reaches 40%, 60%, and 80%, for example.

That is, the central processing unit 30 arranges the thumbnail image, which has been processed so as to be slightly wider than the width of the part of the second division position PD2 in the progress situation informing image 90, so as to be parallel to the XY plane such that the midpoint of the lower side is made to coincide with the second division position PD2, when the transmitted rate reaches 40%.

In addition, the central processing unit 30 arranges the thumbnail image, which has been processed so as to be slightly wider than the width of the part of the third division position PD3 in the progress situation informing image 90, so as to be parallel to the XY plane such that the midpoint of the lower side is made to coincide with the third division position PD3, when the transmitted rate reaches 60%.

Furthermore, the central processing unit 30 arranges the thumbnail image, which has been processed so as to be slightly wider than the width of the part of the fourth division position PD4 in the progress situation informing image 90, so as to be parallel to the XY plane such that the midpoint of the lower side is made to coincide with the fourth division position PD4, when the transmitted rate reaches 80%.

However, the central processing unit 30 processes thumbnail images 105 and 115, which have already been arranged, every time the thumbnail image is additionally arranged in the three-dimensional spatial image SP2 such that the background permeability of the thumbnail image with longer elapse time from the arrangement becomes higher.

In addition, the central processing unit 30 changes the non-transmitted rate informing image 107 attached to the device icon 60 to a non-transmitted rate informing image in which a text indicating the non-transmitted rate at this time is described every time the thumbnail image is additionally arranged in the three-dimensional spatial image SP2.

Then, the central processing unit 30 converts the three-dimensional spatial image SP2 into a selected device image configured by a two-dimensional plane image by projecting the three-dimensional spatial image SP2 onto a two-dimensional plane in the same manner as described above.

In addition, the central processing unit 30 transmits the selected device image data of the selected device image to the display 21 via the display processing unit 41.

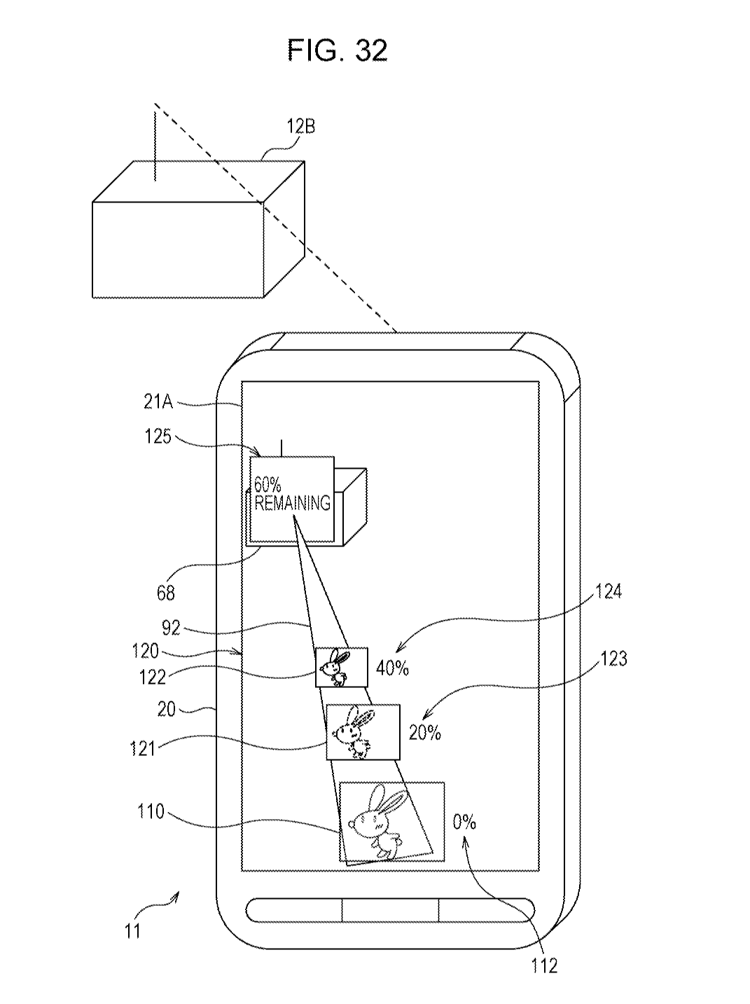

As described above, as shown in FIG. 32, the central processing unit 30 additionally synthesizes the thumbnail images 121 and 122 in a sequential manner on the side of the device icon 68 on the progress situation informing image 92 in the selected device image 120 displayed on the display surface 21A of the display 21.

Accordingly, the central processing unit 30 can allow intuitive recognition of that transmission of the picture image data shown by the thumbnail images 121 and 122 is properly proceeding, by adding the thumbnail images 121 and 122 on the progress situation informing image 92 of the selected device image 120.

In addition, the central processing unit 30 can also allow confirmation of to what extent the picture image data has been transmitted, by the texts 123 and 124 on the right side of the thumbnail images 121 and 122 and the non-transmitted rate informing image 125 attached to the device icon 68 in the selected device image 120.

Then, when the transmission of the picture image data has been completed (the transmitted rate has reached 100%), the central processing unit 30 deletes all thumbnail images 105 and 115 arranged until the timing as well as the non-transmitted rate informing images 107 and 117 in the three-dimensional spatial image SP2.

In addition, the central processing unit 30 processes (expands or contracts) the thumbnail image 102 indicating the picture image data which has already been transmitted so as to have a slightly narrower width than the width of the device icon 60.

Moreover, the central processing unit 30 changes the non-transmitted rate informing image attached to the device icon 60 in the three-dimensional spatial image SP2 to the processed thumbnail image.

Then, the central processing unit 30 converts the three-dimensional spatial image SP2 into a selected device image configured by a two-dimensional plane image by projecting the three-dimensional spatial image SP2 onto a two-dimensional plane in the same manner as described above.

In addition, the central processing unit 30 sends the selected device image data of the selected device image to the display 21 via the display processing unit 41.

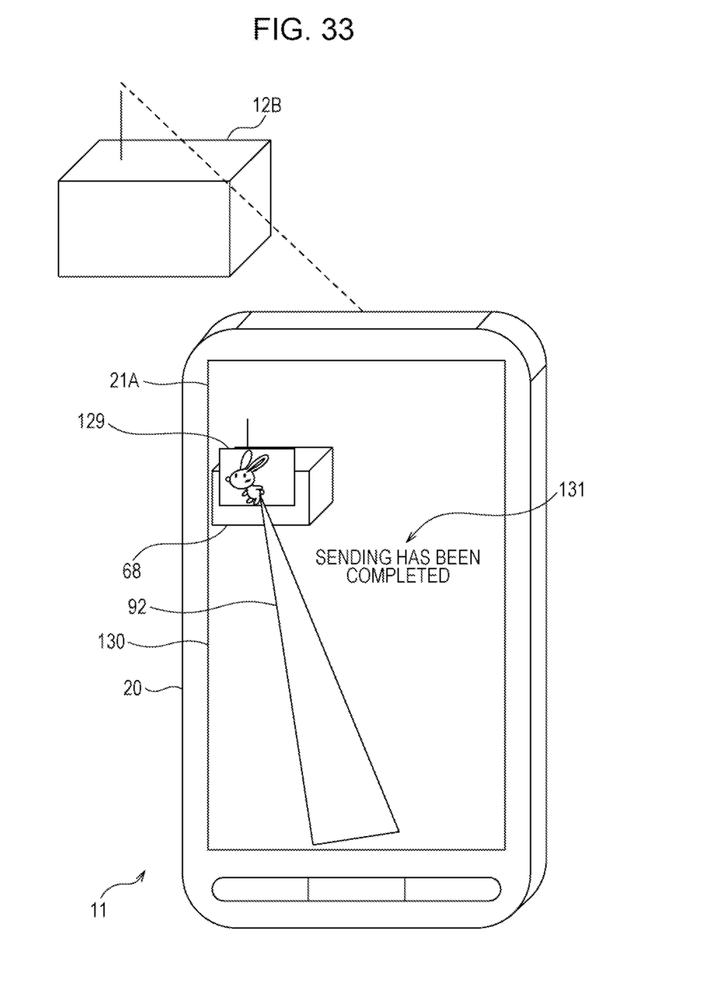

In so doing, the central processing unit 30 displays the selected device image 130 in which the thumbnail image 129 is attached to the device icon 68 as shown in FIG. 33 on the display surface 21A of the display 21 based on the selected device image data.

Accordingly, the central processing unit 30 can allow intuitive recognition of that the transmission of the picture image data has been completed, by the deletion of the thumbnail images 110, 121, and 122 from the progress situation informing image 92 by the selected device image 130 and the attachment of the thumbnail image 129 to the device icon 68.

In addition, the central processing unit 30 displays the text 131 of “transmission has been completed” indicating that the transmission of the picture image data has been completed in the selected device image 130.

Accordingly, the central processing unit 30 can allow the user to confirm that the transmission of the picture image data has been completed, by such a text 131 in the selected device image 130.

In so doing, the central processing unit 30 can transmit other picture image data to the communication target device 12B in the same manner as described above while informing the progress situation of the transmission processing via the selected device image.

In addition, when sound data is transmitted to the communication target device 12B, the central processing unit 30 performs basically the same processing as that in the case of transmitting picture image data with the use of an image in which a text indicating a title of sound is described.

In so doing, the central processing unit 30 can also transmit transmission target sound data to the communication target device 12B while informing the progress situation of the transmission processing via the selected device image.

In addition, when picture image data or sound data is transmitted from the communication target device 12B, the central processing unit 30 firstly receives picture attribute data or sound attribute data transmitted from the device 12B.

Thereafter, the central processing unit 30 processes and displays the selected device image in an order which is basically opposite to that in the aforementioned transmission of the picture image data with the use of the picture attribute data or the sound attribute data while receiving picture image data or sound data transmitted from the device 12B.

In so doing, even when picture image data or sound image data is transmitted from the device 12B, the central processing unit 30 can receive the picture image data or the sound data while informing the progress situation of the receiving processing via the selected device image.

In addition, when predetermined time has passed after transmission and receiving of picture image data or sound data was completed, the central processing unit 30 returns the selected device image to be displayed on the display surface 21A of the display 21 from the selected device image 130 for informing of the completion of transmission and receiving to the aforementioned selected device image 91 (FIG. 24).

That is, when predetermined time has passed after transmission and receiving of picture image data or sound data was completed, the central processing unit 30 displays again the selected device image 91 for informing of establishment of communication connection with the communication target device 12B on the display surface 21A of the display 21.

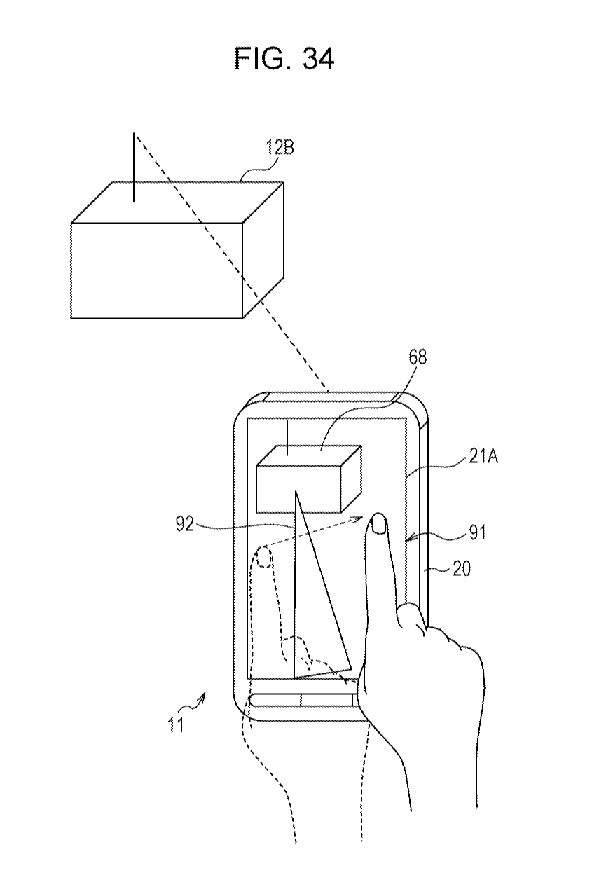

Incidentally, as shown in FIG. 34, when the user performs a sliding operation so as to cross across the progress situation informing image 92 with a tip end of a finger or the like on the selected device image 91 being displayed, the central processing unit 30 recognizes that disconnection of the communication connection with the device 12B has been instructed.

Accordingly, the central processing unit 30 disconnects the communication connection with the device 12B with which communication connection has been made until then. In addition, the central processing unit 30 processes the selected device image data in response to the disconnection of the communication connection.

Then, the central processing unit 30 sends the processed selected device image data to the display 21 via the display processing unit 41.

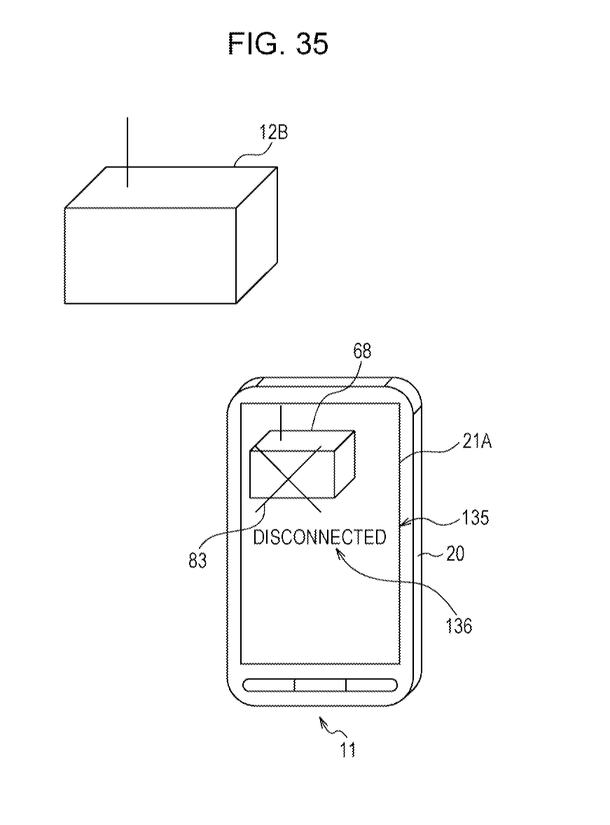

In so doing, the central processing unit 30 displays the selected device image 135 as shown in FIG. 35 on the display surface 21A of the display 21 based on the selected device image data.

In such a case, in the selected device image 135, a text 136 of “disconnected” indicating that the communication connection with the communication target device 12B has been disconnected is arranged, for example.

Accordingly, the central processing unit 30 can inform the user of that the communication connection with the communication target device 12B shown by the selected device image 135 has been disconnected, by the text 136 in the selected device image 135.

However, the central processing unit 30 overlaps the device finding mark 83 on the device icon 68 in the selected device image 135 at this time.

Therefore, the central processing unit 30 can allow confirmation of that the communication connection with the communication target device 12B has been disconnected by stopping the operation not on the side of the device 12B but on the side of the mobile terminal 11 due to the user's instruction, for example, with such a device finding mark 83.

Incidentally, when predetermined time has passed after the disconnection of the communication connection, the central processing unit 30 deletes the text 136 indicating that the communication connection with the communication target device 12B has been disconnected from the inside of the selected device image displayed on the display surface 21A of the display 21.

Then, the central processing unit 30 is brought to be in a standby state for waiting for an instruction of completion of the data transmission receiving function or an instruction of reconnection with the communication target device 12B while informing of the communication target device 12B by the selected device image.

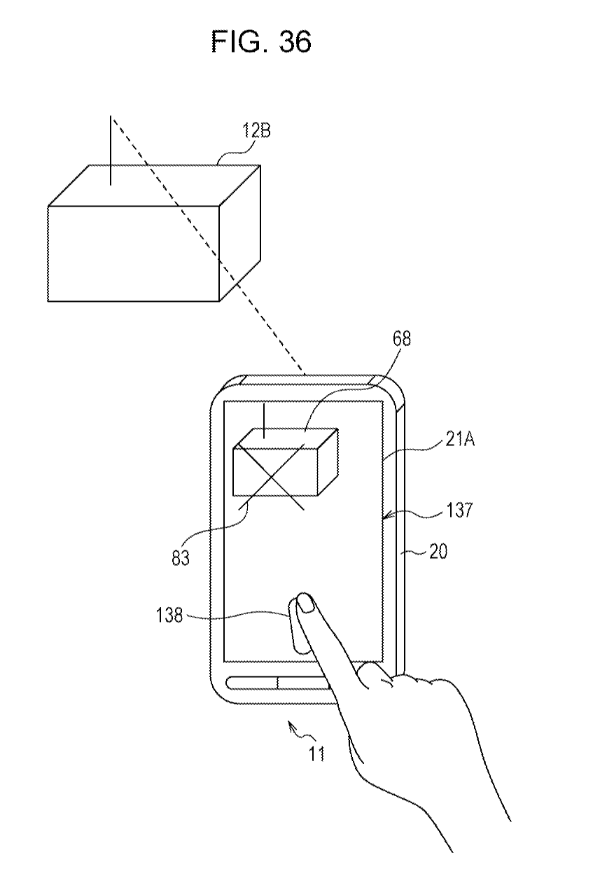

If a sliding operation is performed by the user on the selected device image 137 as shown in FIG. 36, for example, in this state, the central processing unit 30 depicts a line drawing 138 showing a track of the sliding operation in the selected device image 137.

That is, the central processing unit 30 can allow the user to confirm how the sliding operation is being performed, with the line drawing 138 depicted within the selected device image 137 at this time.

Then, when it is detected that the sliding operation has been performed over a length, which is equal to or longer than a predetermined length, from a part closer to the lower side toward the device icon 68 on the selected device image 137 at this time, the central processing unit 30 recognizes that reconnection with the communication target device 12B shown by the device icon 68 has been instructed.

At this time, the central processing unit 30 moves on to a communication connection mode and sequentially executes again the same search processing, authentication processing, and communication setting processing as described above as the communication connection processing for establishing a communication connection with the communication target device 12B shown by the selected device image 137.

In so doing, the central processing unit 30 can establish a communication connection again with the communication target device 12B (that is, establishes again the communication connection) in response to the user's instruction even if the communication connection with the communication target device 12B is once disconnected.

In addition, when the completion of the data transmission receiving function has been instructed by the user via the operation buttons 23 or the tough panel 22 in the aforementioned standby state, the central processing unit 30 completes the data transmission receiving function in response thereto.

### 1-5. Procedure of Communication Connection Processing

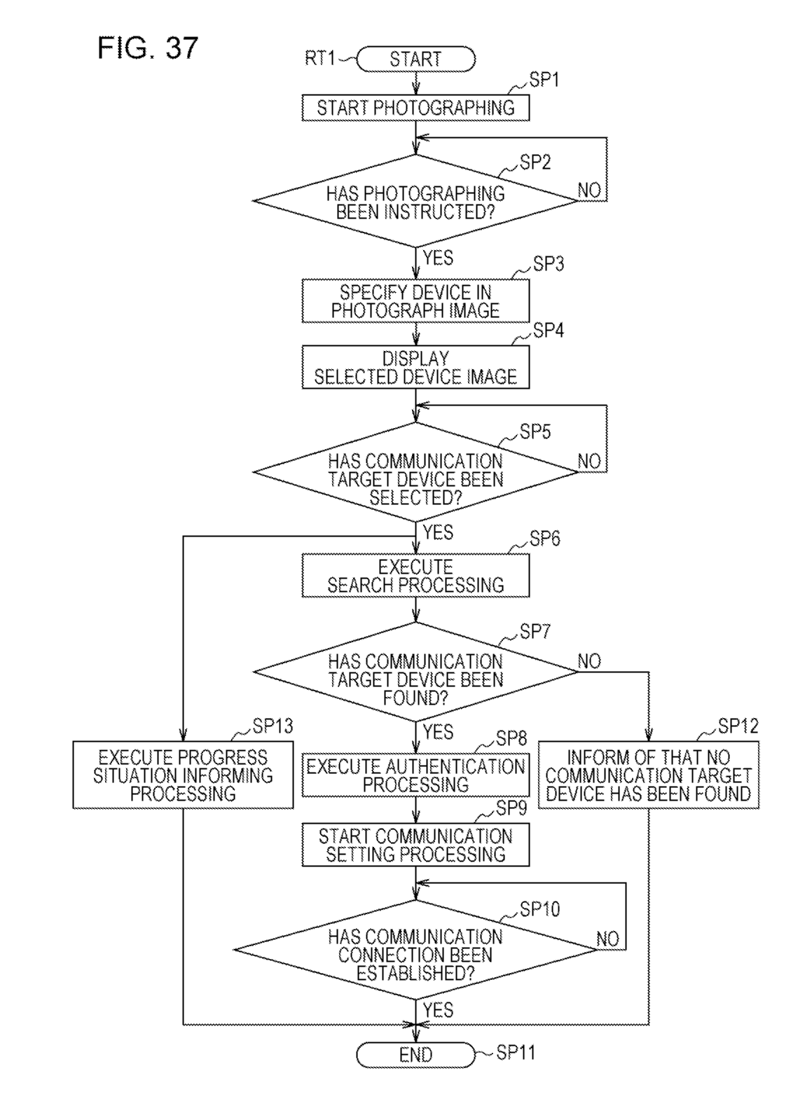

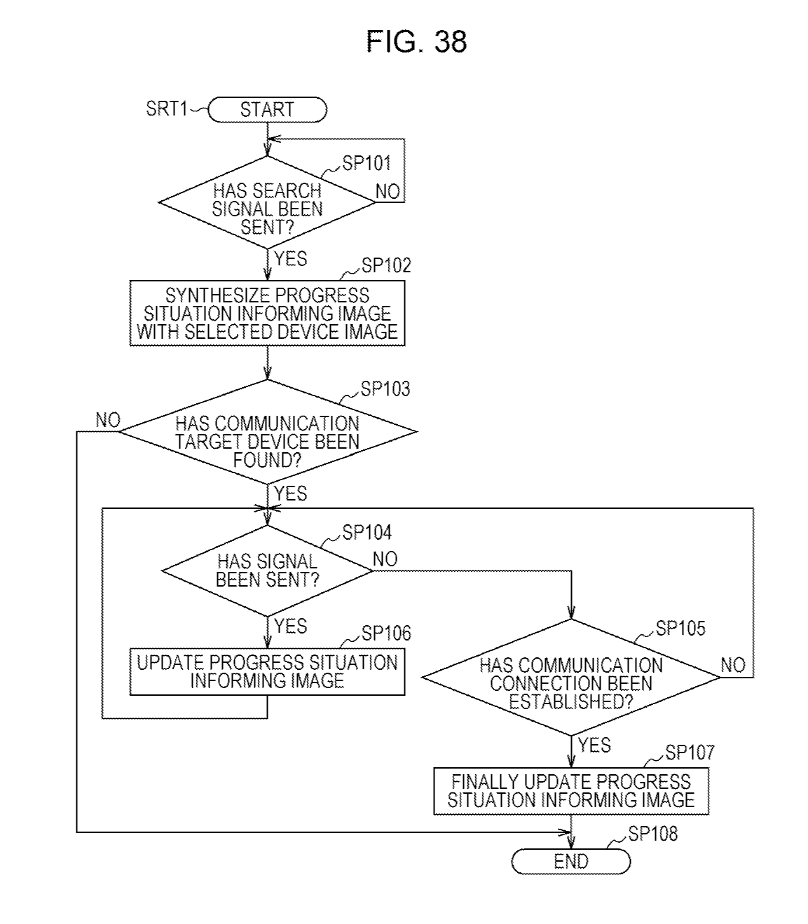

Next, a communication connection processing procedure RT1 executed by the central processing unit 30 of the mobile terminal 11 will be described with the use of the flowcharts shown in FIGS. 37 and 38.

When the central processing unit 30 shifts to the communication connection mode in response to the user's instruction, the central processing unit 30 starts the communication connection processing procedure RT1 shown in FIG. 37 based on a communication connection program developed on the RAM 32.

When the communication connection processing procedure RT1 has been started, the central processing unit 30 starts imaging around the mobile terminal 11 in Step SP1 and moves on to the next Step SP2.

The central processing unit 30 waits for an instruction of taking a picture by the user in Step SP2, and takes a picture of the imaging range, which the imaging lens 24 is made to face, to generate picture image data if taking the picture is instructed, and then moves on to the next Step SP3.

The central processing unit 30 specifies devices 12A to 12N photographed in the picture image in Step SP3 and moves on to the next Step SP4.

In Step SP4, the central processing unit 30 generates a selected device image based on in-picture device positions of the devices 12A to 12N photographed in the picture image.

Then, the central processing unit 30 displays the selected device image on the display surface 21A of the display 21 and moves on to the next Step SP5.

In Step SP5, the central processing unit 30 determines whether or not a communication target among the devices 12A to 12N has been selected by the user.

If a positive result is obtained in this Step SP5, this means that a picture of only one among the devices 12A to 12N has been taken by the user and the one among the devices 12A to 12N has been selected as a communication target by taking a picture.

If such a positive result is obtained in Step SP5, the central processing unit 30 moves on to the next Step SP6.

On the other hand, if a negative result is obtained in Step SP5, this means that a picture of a plurality of devices 12A to 12N has been taken by the user.

If such a negative result is obtained in Step SP5, the central processing unit 30 waits for that one of the devices 12A to 12N is arbitrarily selected as a communication by the user on the selected device image.

Then, if one of the devices 12A to 12N is selected as a communication target by the user, the central processing unit 30 moves on to the next Step SP6.

In SP6, the central processing unit 30 executes search processing and moves on to the next Step SP7, and determines whether or not a communication target among the devices 12A to 12N has been found in Step SP7.

If a positive result is obtained in this Step SP7, this means that a search response signal replied from the one of the devices 12A to 12N has been received as a result of transmission of a search signal for the communication target among the devices 12A to 12N in Step SP6.

That is, such a positive result represents that it has been confirmed that the communication target among the devices 12A to 12N is in a communicatable state as a result of searching for the communication target among the devices 12A to 12N.

If a positive result is obtained in Step SP7, the central processing unit 30 moves on to the next Step SP8.

The central processing unit 30 executes authentication processing with the communication target among the devices 12A to 12N in Step SP8 and then moves on to the next Step SP9.

The central processing unit 30 starts communication setting processing with the communication target among the devices 12A to 12N and transmits a setting request signal to the communication target among the devices 12A to 12N in Step SP9, and then moves on to the next Step SP10.

In Step SP10, the central processing unit 30 waits for establishment of communication connection with the communication target among the devices 12A to 12N.

Then, when a permission response signal replied from the communication target among the devices 12A to 12N has been received, and it is recognized that communication connection with the communication target among the devices 12A to 12N has been established, the central processing unit 30 moves on to the next Step SP11 and completes such a communication connection processing procedure RT1.

In addition, if a negative result is obtained in the aforementioned Step SP7, this represents that the communication target among the devices 12A to 12N stops an operation and the search response signal has not been received as a result of the transmission of the search signal in Step SP6.

That is, such a negative result represents that it has been confirmed that the communication target among the devices 12A to 12N is not in a communicatable state as a result of searching for the communication target among the devices 12A to 12N.

If such a negative result is obtained in Step SP7, the central processing unit 30 moves on to Step SP12.

Then, the central processing unit 30 informs the user of that the communication target among the devices 12A to 12N could not be found via the selected device image in Step SP12, then moves on to Step SP11, and completes such a communication connection processing procedure RT1.

Incidentally, while the central processing unit 30 moves on to Step SP6 as described above to sequentially execute the following processing when a positive result is obtained in Step SP5, the central processing unit 30 also moves on to Step SP13 as well when a positive result is obtained in this Step SP5.

Then, in Step SP13, the central processing unit 30 executes processing in Step SP6 to Step SP10 in parallel (in a time division manner in practice) and executes progress situation informing processing for informing of a progress situation of communication connection processing.

When the progress situation informing processing is executed in Step SP13 in practice, the central processing unit 30 starts a sub-routine SRT1 of the progress situation informing processing shown in FIG. 38 based on a communication connection program developed on the RAM 32.

When the sub-routine SRT1 of the progress situation informing processing has been started, the central processing unit 30 executes search processing and waits for transmission of a search signal in Step SP101 and moves on to the next Step SP102 when the search signal is transmitted.

In Step SP102, the central processing unit 30 synthesizes a progress situation informing image with the selected device image.

Then, the central processing unit 30 changes the selected device image, which has been displayed on the display surface 21A of the display 21 until then, to the selected device image in which the progress situation informing image has been synthesized and moves on to the next Step SP103.

In Step SP103, the central processing unit 30 determines whether or not a communication target among the devices 12A to 12N has been found.

If a positive result is obtained in this Step SP103, this represents that the communication target among the devices 12A to 12N has been found, that is, the communication target among the devices 12A to 12N is in a communicatable state.

If such a positive result is obtained in Step SP103, the central processing unit 30 moves on to the next Step SP104.

In Step SP104, the central processing unit 30 determines which signal among a start request signal, an authentication request signal, and a setting request signal has been transmitted to the communication target among the devices 12A to 12N.

If a negative result is obtained in this Step SP104, this represents that a signal to be transmitted to the communication target among the devices 12A to 12N is being generated or that reply of a permission response signal from the communication target among the devices 12A to 12N is being waited for.

If such a negative result is obtained on Step SP104, the central processing unit 30 moves on to Step SP105.

In Step SP105, the central processing unit 30 determines whether or not communication connection with the communication target among the devices 12A to 12N has been established.

If a negative result is obtained in this Step SP105, this represents that communication connection has not been established since the permission response signal has not yet been replied from the communication target among the devices 12A to 12N.

If such a negative result is obtained in Step SP105, the central processing unit 30 returns to Step SP104.

Accordingly, the central processing unit 30 cyclically repeats the processing in Step SP104 and Step SP105 thereafter until a positive result is obtained in any of Step SP104 and Step SP105.

In so doing, the central processing unit 30 waits for completion of generating a signal to be transmitted to the communication target among the devices 12A to 12N or reply of a permission response signal from the communication target among the devices 12A to 12N.

In addition, if a positive result is obtained in Step SP104, this represents that a signal among the start request signal, the authentication request signal, and the setting request signal has been generated and the generated signal has been transmitted to the communication target among the devices 12A to 12N.

If such a positive result is obtained in Step SP104, the central processing unit 30 moves on to the next Step SP106.

In Step SP106, the central processing unit 30 updates the progress situation informing image in the selected device image.

Then, the central processing unit 30 changes the selected device image, which has been displayed on the display surface 21A of the display 21 until then, to a selected device image in which a progress situation informing image has been updated and returns to Step SP104.

Accordingly, the central processing unit 30 cyclically repeats the processing in Step SP104 and Step SP106 thereafter until a positive result is obtained in Step SP105.

In so doing, the central processing unit 30 updates the progress situation informing image every time the signal is transmitted to the communication target among the devices 12A to 12N as the progress situation of the communication connection processing.

Thereafter, if a positive result is obtained in Step SP105, this represents that the permission response signal replied from the communication target among the devices 12A to 12N has been received and communication connection has been established.

If such a positive result is obtained in Step SP105, the central processing unit 30 moves on to the next Step SP107.

Then, in Step SP107, the central processing unit 30 updates the progress situation informing image in the selected device image so as to represent that the communication connection has been established.

Then, the central processing unit 30 changes the selected device image, which has been displayed on the display surface 21A of the display 21 until then, to the selected device image in which the progress situation informing image has been updated and moves on to the next Step SP108.

In so doing, the central processing unit 30 completes the sub-routine SRT1 of the progress situation informing processing in Step SP108 and moves on to Step SP11 described above with FIG. 37.

In addition, if a negative result is obtained in the aforementioned Step SP103, this represents that the communication target among the devices 12A to 12N could not be found.

If such a negative result is obtained in Step SP103, the central processing unit 30 moves on to Step SP108 and completes the sub-routine SRT1 of the progress situation informing processing, and then moves on to Step SP11 described above with FIG. 37.

### 1-6. Operations and Effects of Embodiment

In the above configuration, when the communication connection processing is started in the communication connection mode, the mobile terminal 11 operates the camera unit 45 and allows the user to take a picture of the devices 12A to 12N to select a communication target among the devices 12A to 12N.

Then, the mobile terminal 11 generates a selected device image showing the communication target among the devices 12A to 12N selected by taking a picture and displays the selected device image on the display surface 21A of the display 21.

In this state, when transmission and receiving of signals are started in practice in order to make communication connection with the communication target among the devices 12A to 12N as a part of communication connection processing, the mobile terminal 11 synthesizes a progress situation informing image for informing of a progress situation of communication connection processing with the selected device image.

Then, the mobile terminal 11 updates the progress situation informing image to be synthesized with the selected device image in accordance with the progress situation of the communication connection processing while transmitting and receiving signals for the communication connection with the communication target among the devices 12A to 12N.

Accordingly, the mobile terminal 11 can allow the user to recognize the progress situation of the communication connection processing by the progress situation informing image synthesized with the selected device image while the communication connection processing is executed.

Accordingly, the mobile terminal 11 can allow waiting for establishment of the communication connection in a state in which it is possible to predict when the communication connection with the communication target among the devices 12A to 12N will be established.

With the above configuration, the mobile terminal 11 starts the communication connection processing for establishing a communication connection with a device among the devices 12A to 12N selected as a communication target, displays a selected device image showing the communication target among the devices 12A to 12N, and updates a progress situation informing image in the selected device image in accordance with the progress situation of the communication connection processing by synthesizing the progress situation informing image for informing the progress situation of the communication connection processing with the selected device image. In so doing, the mobile terminal 11 can allow the user to recognize the progress situation of the communication connection processing by the progress situation informing image in the selected device image while the communication connection processing is executed, and as a result, allow the user to wait for establishment of the communication connection in a state in which it is possible to predict about when the communication connection with the communication target among the devices 12A to 12N will be established. Accordingly, for the mobile terminal 11, it is possible to remarkably enhance the usability of the mobile terminal 11.

In addition, the mobile terminal 11 is configured to synthesize the progress situation informing image at a position which is different from an arrangement position of the device icon indicating the communication target among the devices 12A to 12N in the selected device image.

In addition, the mobile terminal 11 is configured to sequentially extend the entirety of the progress situation informing image so as to bring one end of the image to be closer to the device icon while fixing the other end of the image when the progress situation informing image is updated in accordance with the progress situation of the communication connection processing.

Accordingly, the mobile terminal 11 can allow the user to feel as if a connection line for connecting the mobile terminal 11 to the communication target among the devices 12A to 12N was gradually extended from the mobile terminal 11 toward the communication target among the devices 12A to 12N and intuitively recognize that the communication connection processing is properly proceeding, by the sequentially updated progress situation informing image.

Moreover, the mobile terminal 11 is configured to execute final update of the progress situation informing image and brings the other end of the image of the progress situation informing image to be in contact with the device image when the communication connection with the communication target among the devices 12A to 12N has been established as the progress situation of the communication connection processing.

That is, the mobile terminal 11 is configured to express as if the mobile terminal 11 and the communication target among the devices 12A to 12N were connected in a wired manner in the progress situation informing image when the communication connection with the communication target among the devices 12A to 12N has been established.

Accordingly, the mobile terminal 11 can allow intuitive recognition of the establishment of the communication connection when the communication connection with the communication target among the devices 12A to 12N has been established.

Moreover, the mobile terminal 11 is configured such that the image length of the progress situation informing image is sequentially extended equal length by length when the progress situation informing image is sequentially updated in accordance with the progress situation of the communication connection processing.

Accordingly, the mobile terminal 11 can allow the user to easily predict how long the user has to wait until the communication connection between the mobile terminal 11 and the communication target among the devices 12A to 12N is established.

In addition to this, the mobile terminal 11 is configured to sequentially update the progress situation informing image every time the mobile terminal 11 transmits signals for communication connection (that is, the search signal, the start request signal, the authentication request signal, and the setting request signal) to the communication target among the devices 12A to 12N as the progress situation of the communication connection processing.

Accordingly, the mobile terminal 11 can reduce variation in an update cycle of the progress situation informing image, and as a result, the mobile terminal 11 can allow the user to easily and appropriately predict about when the communication connection will be established while the user waits for the establishment of the communication connection.

Furthermore, if the progress situation informing image is sequentially updated every time the signals for communication connection are transmitted to the communication target among the devices 12A to 12N, the mobile terminal 11 can execute processing for updating the progress situation informing image while the mobile terminal 11 waits for replies of the signals (that is, the search response signal, the start response signal, the authentication response signal, and the permission response signal) from the communication target among the devices 12A to 12N in practice.

Accordingly, the mobile terminal 11 can avoid increase in processing burden while executing the progress situation informing processing as a part of the communication connection processing.

### 2. Modified Examples

### [2-1. Modified Example 1]

In the aforementioned embodiment, the description was given of a case in which the selected device image was generated with the three-dimensional spatial image SP2 in which the device icon was arranged in the communication connection mode.

However, the present invention is not limited thereto, and a picture image generated by taking a picture of the communication target among the devices 12A to 12N may be used as it is as the selected device image.

In addition, according to the present invention, a captured image obtained by imaging one of the devices 12A to 12N prior to taking the picture may be used as the selected device image.

Furthermore, according to the present invention, a CG (Computer Graphics) image or an animated image generated in advance for representing one of the devices 12A to 12N may be used as the selected device image.

Moreover, according to the present invention, a picture of one of the devices 12A to 12N is taken, and a picture image is generated and stored in advance. Then, according to the present invention, a picture may not be taken in particular in the communication connection mode, and a communication target among the devices 12A to 12N may be selected from a list, for example, and a picture image in which the selected one of the devices 12A to 12N is photographed may be used as the selected device image from among a plurality of stored picture images.

Furthermore, according to the present invention, a picture image based on a picture image generated by taking a picture of the communication target among the devices 12A to 12N may be used by arranging a device icon generated as a two-dimensional plane image at an in-picture device position.

In addition, according to the present invention, the progress situation informing image configured as a two-dimensional plane image or a CG image may directly be synthesized on the selected device image when the selected device image configured by a picture image or a captured image or the selected device image generated by arranging the device icon in the picture image is used.

In addition, according to the present invention, if code stickers 56 is attached to the imaged one of the devices 12A to 12N when the progress situation informing image configured by a CG image is synthesized on the selected device image, a position of the two-dimensional code 55 in the picture image (for example, a center position of the two-dimensional code 55) is detected.

In addition, according to the present invention, an imaged posture of the two-dimensional code 55 (the shape of the two-dimensional code 55 in the picture image) is extracted as a vector from the picture image.

On the other hand, according to the present invention, when the code sticker 56 is not attached to the imaged one of the devices 12A to 12N, a position of an outline of the one of the devices 12A to 12N (for example, a center position of the outline of the one of the devices 12A to 12N) is extracted in the picture image.

In addition, according to the present invention, an imaged posture of the one of the devices 12A to 12N (the shape of the outline of one of the devices 12A to 12N in the picture image) is extracted as a vector from the picture image.

In addition, according to the present invention, imaged postures (outline shapes of the devices 12A to 12N in the picture image) of the devices 12A to 12N are extracted as vectors from the picture image.

In addition, according to the present invention, positional and angular relationships between the imaging lens 24 and the synthesis start position of the progress situation informing image selected in advance, for example (for example, a position to which the other end of the image of the progress situation informing image is fixed in the picture image) are also detected.

In so doing, according to the present invention, it is possible to synthesize the progress situation informing image configured by a CG image with the selected device image based on the detected positional and angular relationships as if the progress situation informing image was viewed from the imaging lens 24 in a three-dimensional manner, and it is possible to update the progress situation informing image.

In addition, according to the present invention, if only one of the devices 12A to 12N is photographed in the captured image, for example, in the case of using the captured image as the selected device image as described above, the captured image may be used as it is as the selected device image.

Moreover, according to the present invention, when an imaging range is changed and another one of the devices 12A to 12N is imaged after the communication connection with only one of the devices 12A to 12N photographed in the captured image, a counterpart of the communication connection may automatically be shifted to another one of the devices 12A to 12N.

Moreover, according to the present invention, if a plurality of devices 12A to 12N is photographed in the captured image even when the captured image is used as the selected device image, a picture is automatically taken.

In addition, according to the present invention, a communication target among the devices 12A to 12N may be selected on the picture image, and the picture image may be used as the selected device image as it is or by arranging a device icon.

That is, according to the present invention, using the captured image as it is as the selected device or using the captured picture image as the selected device may be shifted in accordance with the number of the devices 12A to 12N photographed in the captured image.

### 2-2. Modified Example 2

In addition, in the aforementioned embodiment, the description was given of a case in which one of the devices 12A to 12N was selected on the picture image for establishing a communication connection if a plurality of devices 12A to 12N is photographed in the picture image in the communication connection mode.

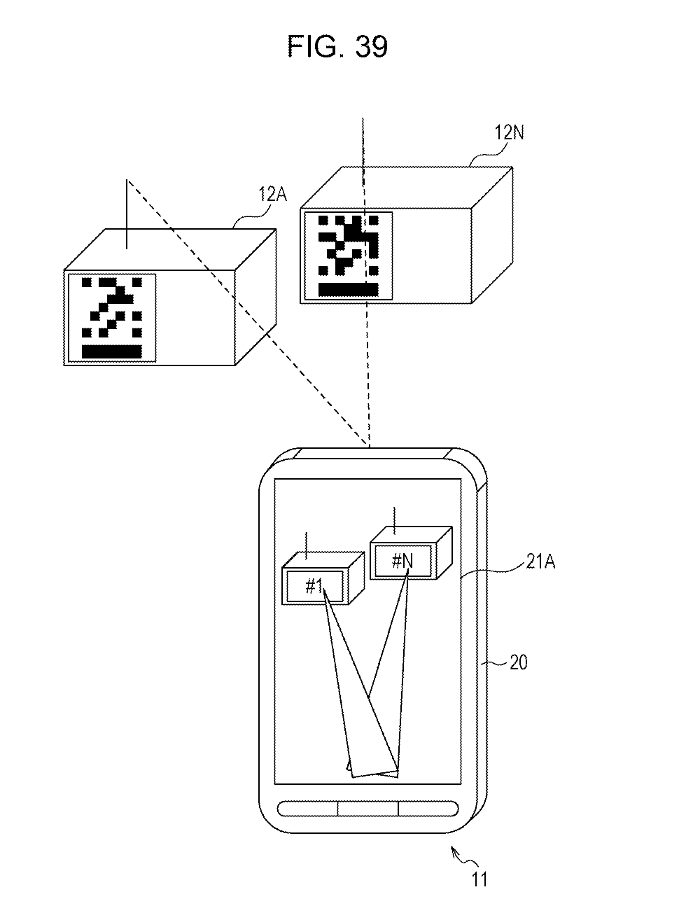

However, the present invention is not limited thereto, and communication connection may be made with all devices 12A to 12N photographed in the picture image when a plurality of devices 12A to 12N is photographed in the picture image as shown in FIG. 39.

In addition, according to the present invention, a change of the devices 12A to 12N with which communication connection will be made may be instructed by dragging the progress situation informing image, for example, after establishing a communication connection with one of the devices 12A to 12N which has been arbitrarily selected from among the plurality of devices 12A to 12N photographed in the picture image.

In addition, according to the present invention, it is also possible to inform of that the picture of the devices 12A to 12N is to be taken when the devices 12A to 12N are not photographed at all in the picture image generated by taking a picture (it is not possible to specify the devices 12A to 12N).

In addition, according to the present invention, search for the devices 12A to 12N may be executed when the communication connection processing is started. Then, according to the present invention, a list of the devices 12A to 12N which have been found in the search may be displayed when the devices 12A to 12N are not photographed in the picture image to inform of communicable devices 12A to 12N.

### 2-3. Modified Example 3

In the aforementioned embodiment, the description was given of a case in which when a communication target among the devices 12A to 12N could not be found in the communication connection mode, informing of this was made.

However, the present invention is not limited thereto, and even when signals other than the search response signal cannot be received due to occurrence of communication error or the like while the mobile terminal 11 transmits and receives the signals for communication connection with the communication target among the devices 12A to 12N, informing of the situation may be made.

In addition, according to the present invention, when signals other than the search response signal cannot be received by the mobile terminal 11, informing of processing failed due to the fact that the signals cannot be received may be made in accordance with the processing being executed at that time.

In addition, according to the present invention, an upper limit for the number of the apparatuses for which it is possible to make communication connection at the same time is set for the communication target devices 12A to 12N, and if communication connection is refused since the upper limit number of apparatuses have already made communication connection with the communication target among the devices 12A to 12N when the mobile terminal 11 transmits the search signal, it is possible to inform the user of the situation.

### 2-4. Modified Example 4

Moreover, in the aforementioned embodiment, the description was given of a case in which a terminal position at which the other end of the image of the progress situation informing image was located was selected in advance for synthesizing the progress situation informing image with the selected device image.

However, the present invention is not limited thereto, and the terminal position may automatically be determined at a location which is part from an in-picture device position in the picture image or a location which is apart from an in-space device position in the three-dimensional spatial image in accordance with the in-picture device image in the picture image and the in-space device image in the three-dimensional spatial image every time a picture of the devices 12A to 12N is taken.

In the present invention, according to a configuration, it is possible to synthesize a progress situation informing image for informing of a progress situation of communication connection processing with the use of a vacant space in the picture image or the three-dimensional spatial image even when the devices 12A to 12N are photographed near the lower side of the picture image, for example, in taking the picture of the devices 12A to 12N.

In so doing, according to the present invention, it is possible to prevent that it becomes difficult to determine a degree of update in accordance with the progress situation of communication connection processing due to excessively short progress situation informing image in a picture image or a three-dimensional spatial image.

### 2-5. Modified Example 5

Furthermore, in the above embedment, the description was given of a case in which the progress situation informing image with an isosceles triangle shape, which was updated so as to sequentially extend the entirety in accordance with the progress situation of the communication connection processing was used in order to inform of the progress situation of the communication connection processing.

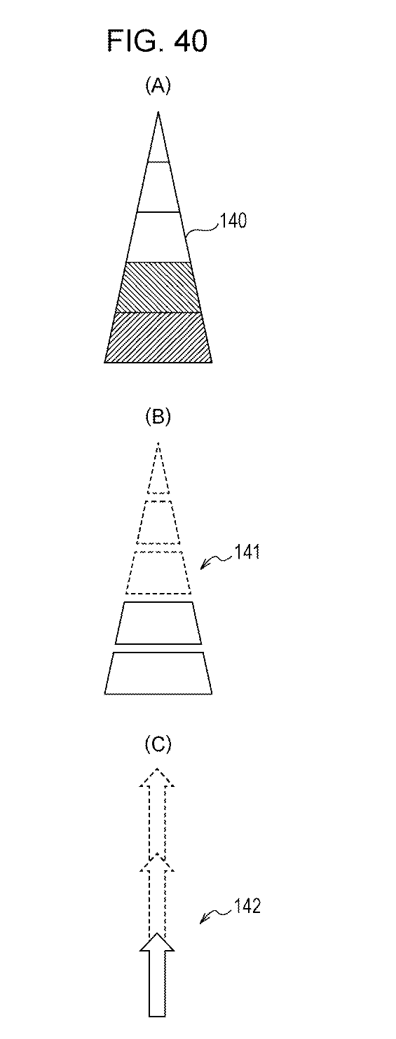

However, the present invention is not limited thereto, and a progress situation informing image 140, which is formed in shape with a blank inner part such as a triangle shape as shown in FIG. 40(A) and synthesized with the selected device image such that the terminal position and the position of one of the devices 12A to 12N (the in-picture device position or the in-space device position) are connected at the start timing of the synthesis, may be used.

In addition, according to the present invention, the progress situation informing image 140 may be updated by gradually filling in the inner part from the side of the other end of the image to the side of one end of the image in accordance with the progress situation of the communication connection processing from a state in which the progress situation informing image 140 is synthesized such that the terminal position and the position of one of the devices 12A to 12N are connected to the selected device image.

In addition, according to the present invention, a progress situation informing image 141 configured by a plurality of blocks may be used as shown in FIG. 40(B).

Furthermore, according to the present invention, the progress situation informing image 141 may be updated such that the blocks are sequentially increased in accordance with the progress situation of the communication connection processing and the terminal position and the position of one of the devices 12A to 12N are finally connected.

Furthermore, according to the present invention, a progress situation informing image 142 configured by an arrow may be used as shown in FIG. 40(C), and the progress situation informing image 142 may be updated such that the entirety is sequentially extended in accordance with the progress situation of the communication connection processing.

In addition, according to the present invention, a display state which is different from that until then (presence of a color, blinking, and the like) may be set for the progress situation informing image in the aforementioned embodiment or the progress situation informing images 140 to 142 shown in FIGS. 40(A) to (C) when the communication connection has been established and the terminal position and the position of one of the devices 12A to 12N are connected.

In the present invention, according to such a configuration, it is possible to more appropriately inform of that communication connection has been established, by a progress situation informing image.

In addition, the present invention is not limited to the progress situation informing image in which the terminal position and the position of one of the devices 12A to 12N are connected, and progress situation informing image configured by a text representing the progress situation of the communication connection processing in percent figures, for example.

### 2-6. Modified Example 6

Furthermore, in the aforementioned embodiment, the description was given of a case in which the total of five levels was selected including the transmission timing of the search signal, the transmission timing of the start request signal, the transmission timing of the authentication request signal, the transmission timing of the setting request signal, and the establishment timing of the communication connection, as the informing levels for the progressing situation of the communication connection processing.

However, the present invention is not limited thereto, and total of four levels of informing levels for the progress situation of the communication connection processing may be selected including the start timing of the search processing, the start timing of the authentication processing, the start timing of the communication setting processing and the establishment timing of the communication connection.

In addition, according to the present invention, total of nine levels may be selected including transmission timing and receiving timing of individual signals for the communication connection and the establishment timing of the communication connection as the informing levels for the progress situation of the communication connection processing.

Moreover, according to the present invention, other various levels may be selected as the informing levels for the progress situation of the communication connection processing in accordance with content of the communication connection processing between the mobile terminal 11 and the communication target among the devices 12A to 12N based on the near-field wireless communication standard applied to near-field wireless communication.

Furthermore, according to the present invention, selection timing of the communication target among the devices 12A to 12N may be included in the informing levels when a selected device image prepared in advance prior to the communication connection processing is used as described above in Modified Example 1.

### 2-7. Modified Example 7

Furthermore, in the aforementioned embodiment, the description was given of a case in which CyberCode 55 expressing device identification information was used to specifying one of the devices 12A to 12N.

However, the present invention is not limited thereto, and CyberCode which expresses at least device attribute information and communication usage information may be used for specifying one of the devices 12A to 12N.

### 2-8. Modified Example 8

Furthermore, in the aforementioned embodiment, the description was given of a case in which CyberCode 55 was used for specifying one of the devices 12A to 12N.

However, the present invention is not limited thereto, and a matrix-type two-dimensional code such as QR (Quick Response) code (registered trademark), DATA MATRIX (registered trademark), Maxi Code (registered trademark) or the like may be used.

In addition, according to the present invention, a stacked-type two-dimensional code such as PDF417 (registered trademark) may be used. Furthermore, according to the present invention, a barcode may be used.

### 2-9. Modified Example 9

Furthermore, in the aforementioned embodiment, the description was given of a case in which the communication connection apparatus according to the present invention was applied to the aforementioned communication connection apparatus 1 with reference to FIG. 1 to FIG. 40 and the mobile terminal 11.

However, the present invention is not limited thereto. And it is possible to apply the present invention to other various kinds of communication connection apparatus having a near-field wireless communication function such as a personal computer, a mobile phone, a PDA (Personal Digital Assistance), a game device, an electronic book reader, or the like.

### 2-10. Modified Example 10

Furthermore, in the aforementioned embodiment, the description was given of a case in which the communication connection program according to the present invention was applied to the communication connection program stored in advance on the ROM 31 of the mobile terminal 11.

In addition, in the aforementioned embodiment, the description was given of a case in which central processing unit 30 of the mobile terminal 11 executed the aforementioned communication connection processing procedure RT1 as described above with reference to FIG. 37 based on the communication connection program.

In addition, in the aforementioned embodiment, the description was given of a case in which the central processing unit 30 of the mobile terminal 11 executed the progress situation informing processing sub-routine SRT1 as described above with reference to FIG. 38 as a part of the communication connection processing based on the communication connection program.

However, the present invention is not limited thereto, and the mobile terminal 11 may install the communication connection program by a computer-readable storage medium on which the communication connection program is stored.

In addition, the central processing unit 30 may execute the communication connection processing procedure RT1 and the progress situation informing processing sub-routine SRT1 based on the installed communication connection program.

In addition, the mobile terminal 11 may install the communication connection program from the outside with the use of a wired or wireless communication medium such as a local area network, the Internet, digital satellite broadcasting, or the like.

In addition, as the computer readable recording medium for installing the communication connection program in the mobile terminal 11 in an executable state may be realized by a package medium such as a flexible disk, for example.

In addition, the computer-readable recording medium for installing the communication connection program in the mobile terminal 11 in an executable state may be realized by a package medium such as a CD-ROM (Compact Disc-Read Only Memory), for example.

Furthermore, the computer-readable recording medium for installing the communication connection program in the mobile terminal 11 in an executable state may be realized by a package medium such as a DVD (Digital Versatile Disc) or the like, for example.

Furthermore, such a computer-readable recording medium may be realized not only by a package medium but by a semiconductor memory, a magnetic disk, or the like on which various programs are temporarily or permanently stored.

In addition, as a means for storing the communication connection program on such a computer-readable recording medium, a wired or wireless communication medium such as a local area network, the Internet, a digital satellite broadcasting, or the like may be used.

Moreover, the communication connection program may be stored on the computer-readable storage medium via various kinds of communication interface such as a router, a modem, or the like.

### 2-11. Modified Example 11

Furthermore, in the aforementioned embodiment, the description was given of a case in which the communication connection processing unit 2 and the central processing unit 30 described above with reference to FIG. 1 to FIG. 40 were applied as the communication connection processing unit which executed communication connection processing for establishing a communication connection with a device selected as a communication target.

However, the present invention is not limited thereto, and it is possible to apply a communication connection processing circuit with a hardware configuration which executes the communication connection processing for establishing a communication connection with the device selected as the communication target.

In addition, according to the present invention, other communication connection processing units with various configurations such as a DSP (Digital Signal Processor), a microprocessor, or the like can be widely applied as the communication connection processing unit.

### 2-12. Modified Example 12

Moreover, in the aforementioned embodiment, the description was given of a case in which the display unit 3 and the display 21 described above with reference to FIG. 1 to FIG. 40 were applied as a display unit which displays the selected device image indicating the communication target device when the communication connection processing was started by the communication connection processing unit.

However, the present invention is not limited thereto, and an externally attached display which is connected to the communication connection apparatus 1 or the mobile terminal 11 in a wired or a wireless manner may be used as the display unit.

### 2-13. Modified Example 13

Furthermore, in the aforementioned embodiment, the description was given of a case in which the progress situation informing unit 4 and the central processing unit 30 described above with reference to FIG. 1 to FIG. 40 were applied as the progress situation informing unit which updates the progress situation informing image to be synthesized with the selected device image in accordance with the progress situation of the communication connection processing by synthesizing the progress situation informing image for informing of the progress situation of the communication connection processing with the selected device image.

However, the present invention is not limited thereto, and a progress situation informing circuit with a hardware configuration, which updates the progress situation informing image to be synthesized with the selected device image in accordance with the progress situation of the communication connection processing by synthesizing the progress situation informing image for informing of the progress situation of the communication connection processing with the selected device image can be applied.

In addition, according to the present invention, other progress situation informing units with various configurations such as a DSP, a microprocessor, and the like can widely be applied as the progress situation informing unit.

### INDUSTRIAL APPLICABILITY

The present invention can be used for a communication connection apparatus such as a smartphone, a mobile phone, a note-type personal computer, or the like.

### REFERENCE SIGNS LIST

1 COMMUNICATION CONNECTION APPARATUS
2 COMMUNICATION CONNECTION PROCESSING UNIT
3 DISPLAY UNIT
4 PROGRESS SITUATION INFORMING UNIT
11 MOBILE TERMINAL
12A TO 12N DEVICE
21 DISPLAY
22 TOUCH PANEL
30 CENTRAL PROCESSING UNIT
45 CAMERA UNIT
50 NEAR-FIELD COMMUNICATION PROCESSING UNIT
51 NEAR-FIELD ANTENNA
65, 66, 69, 78, 82, 86, 89, 91 SELECTED DEVICE IMAGE
67, 68, 70, 71 DEVICE ICON
77, 81, 85, 88, 92, 140, 141, 142 PROGRESS SITUATION INFORMING IMAGE
RT1 COMMUNICATION CONNECTION PROCESSING PROCEDURE
SRT1 PROGRESS SITUATION INFORMING PROCESSING SUB-ROUTINE

1. A communication connection apparatus comprising:
a display unit to display an image of a device selected as a communication target with which to establish a communication connection; and
a processing unit to update a progress informing image for informing progress of a communication connection synthesized with the selected device image.

2. The apparatus of claim 1, wherein the progress informing image is updated, in accordance with a progress of communication connection processing after the communication connection processing is started.

3. The apparatus of claim 1, wherein the processing unit is to position the progress informing image at a different position from the selected device image.

4. The apparatus of claim 1, wherein the processing unit is to control display of the progress informing image such that the entirety of the progress informing image is brought closer to the selected device image.

5. The apparatus of claim 1, wherein the processing unit is to control display of the progress informing image such that a portion of the progress informing image is brought in contact with the selected device image.

6. The apparatus of claim 1, wherein the processing unit is to update the progress informing image such that the progress informing image is sequentially extended in length.

7. The apparatus of claim 1, wherein the processing unit is to update the progress informing image such that the progress informing image is extended in length when an authentication request signal is transmitted to the selected device.

8. The apparatus of claim 1, wherein the processing unit is to update the progress informing image such that the progress informing image is extended in length when a communication setting process is started and a setting request signal is transmitted to the selected device.

9. The apparatus of claim 1, wherein the processing unit is to select a position of the progress informing image in accordance with a position of the selected device.

10. The apparatus of claim 1, wherein the processing unit is to control a display state of the progress informing image, such that the display state when a communication connection is established with the selected device is different from that until the communication connection is established.

11. A method for communication connection comprising:
displaying an image of a device selected as a communication target with which to establish a communication connection; and
updating, by a processor, a progress informing image for informing progress of a communication connection synthesized with the selected device image.

12. A non-transitory recording medium recorded with a program executable by a computer, the program comprising:
displaying an image of a device selected as a communication target with which to establish a communication connection; and
updating a progress informing image for informing progress of a communication connection synthesized with the selected device image.
